(19) United States
(12) Patent Application Publication
(10) Pub. No.: US 2021/0406272 A1
(43) Pub. Date: Dec. 30, 2021

(54) METHODS AND SYSTEMS FOR SUPERVISED TEMPLATE-GUIDED UNIFORM MANIFOLD APPROXIMATION AND PROJECTION FOR PARAMETER REDUCTION OF HIGH DIMENSIONAL DATA, IDENTIFICATION OF SUBSETS OF POPULATIONS, AND DETERMINATION OF ACCURACY OF IDENTIFIED SUBSETS

(71) Applicant: The Board of Trustees of The Leland Stanford Junior University, Palo Alto, CA (US)

(72) Inventors: Stephen W. Meehan, Burnaby (CA); Connor Meehan, Burnaby (CA); Wayne A. Moore, San Francisco, CA (US); Leonore A. Herzenberg, Stanford, CA (US)

(21) Appl. No.: 17/361,288

(22) Filed: Jun. 28, 2021

Related U.S. Application Data
(60) Provisional application No. 63/045,014, filed on Jun. 26, 2020.

(51) Int. Cl. G06F 16/2457; G06F 16/26; G06N 20/00

(52) U.S. Cl. CPC G06F 16/24578; G06N 20/00; G06F 16/26

(57) ABSTRACT

Some embodiments provide methods, systems and computer-readable media that for identifying corresponding distributions of functional subpopulations of cells from high dimensional data across multiple samples and verifying the accuracy of the identified subpopulations.

### RELATED APPLICATIONS

This application claims priority to and benefit of U.S. Provisional Patent Application No. 63/045,014, filed Jun. 26, 2020, the disclosure of which is incorporated herein by reference in its entirety.

### FIELD OF THE INVENTION

Embodiments are related to the fields of data analysis and visualization for multidimensional data (e.g., Hi-D data) (e.g., for cytometry). More specifically, some embodiments are related to determining and defining subpopulations of particles (e.g., different functional subpopulations of cells) from multidimensional measurements of the particles. Some embodiments are related to dimensional reduction for defining subpopulations of individuals in high dimensional data.

### BACKGROUND OF THE INVENTION

The traditional approach to locating clusters (subsets or subpopulations) in high-dimensional (Hi-D) data sets regarding populations, such as those acquired by flow cytometry, is to reduce the data set dimensionality, usually by linear and/or nonlinear one-/two-dimensional mapping or projection strategies usually conducted at least partially manually. This projection pursuit approach has proven to be efficient in some circumstances for analyzing high-dimensional data in a way that avoids a common pitfall, the curse of dimensionality. Usually, cell subsets identified in such user-guided manners are readily biologically interpretable. However, the resolution of such subsets with manual analysis tools is by no means routine. In fact, since these manual analysis methods ultimately rely on user skills to define subset boundaries, subset identification, and quantitation is still more appropriately recognized as an art rather than a science.

Further, there are difficulties and challenges for comparison of samples and implementing gating from sample to sample to identify similar populations of cells. Most flow and mass cytometry applications in biomedical studies are based on comparisons between/among control and test samples. Dissimilarities between/among samples may be due to drug treatment regime, progression of disease, response to therapies, etc. To study these dissimilarities across samples, the populations of cells in each sample may be clustered to reveal phenotypically distinct cell subsets that can then be matched and compared between samples. Despite the widespread use of flow and mass cytometry to evaluate outcomes in the laboratory and the clinic, current analysis methods for sample comparison and matching between samples still require further development to fully accommodate real-world flow/mass cytometry data. At present, methods for samples comparison and matching are either computationally expensive and affected by the curse of dimensionality or fail in the presence of small changes due to instrument noise, calibration, etc., that are very common in flow cytometry and similar type of data as explained below.

Improved methods are needed to efficiently and accurately identify relevant subsets among compatible sample populations.

### SUMMARY

Some embodiments are directed to methods, systems, and computer readable media for identifying distributions of functional subpopulations of cells from high dimensional data in multiple samples and verifying the accuracy of the identified subpopulations.

According to one aspect, the described invention provides a method for identifying distributions of functional subpopulations of cells. The method includes obtaining or accessing first training data including measurements of a plurality of parameters of cells in a first training cell population and including one of a plurality of subpopulation labels for each cell in the first training cell population, the plurality of parameters including more than five parameters, and the subpopulation labels identifying different functional subpopulations of cells in the first training cell population. The method also includes performing supervised uniform manifold approximation and projection on the first training data using the subpopulation labels for supervision to produce first reduced parameter data corresponding to measurements of the plurality of parameters of cells in the first training cell population in a reduced parameter dataspace. The method also includes obtaining or accessing second data including measurements of the plurality of parameters for cells in a second cell population. The method also includes performing template-guided uniform manifold approximation and projection on the second data employing the first reduced parameter data corresponding to the first training cell population as template data to produce second reduced parameter data corresponding to measurements of the plurality of parameters of cells in the second cell population. The method also includes identifying subpopulations of the second cell population and recognizing at least some of the subpopulations of the second cell population as corresponding to at least some of the subpopulation labels of cells in the first training cell population based on the second reduced parameter data.

In some embodiments of the method, the method also includes applying quadrative form matching to the subpopulations for the first training cell population and the identified subpopulations of the second cell population based on the second reduced parameter data to determine the accuracy of the identification and recognition of subpopulations of the second cell population as corresponding to subpopulations of the first training cell population.

In some embodiments, applying the quadrative form matching to the subpopulations for the first training cell population and the identified subpopulations of the second cell population based on the second reduced parameter data to determine the accuracy of the identification and recognition of at least some of the subpopulations of the second cell population as corresponding to subpopulations of the first training cell population includes: determining a first set of dissimilarity scores for corresponding matching subpopulations between labeled subpopulations in the first training cell population and subpopulations in the second cell population identified based on the second reduced parameter data; and determining a first overall dissimilarity score based on the first set of dissimilarity scores.

In some embodiments, applying the quadrative form matching to the subpopulations for the first training cell population and the identified subpopulations of the second cell population based on the second reduced parameter data to determine the accuracy of the identification and recognition of at least some of the subpopulations of the second cell population as corresponding to subpopulations of the first training cell population includes: two or more of: determining a first set of dissimilarity scores for corresponding matching subpopulations between labeled subpopulations in the first training cell population and subpopulations in the second cell population identified based on the second reduced parameter data, and determining a first overall dissimilarity score based on the first set of dissimilarity scores; determining a second set of dissimilarity scores for corresponding matching subpopulations between labeled subpopulations in the first training cell population and subpopulations in the second cell population identified based on obtained third data including subpopulation labels identifying different functional subpopulations of cells in the second cell population based on external classification, and determining a second overall dissimilarity score based on the second set of dissimilarity scores; and determining a third set of dissimilarity scores for corresponding matching subpopulations between subpopulations in the second cell population identified based on obtained third data including subpopulation labels identifying different functional subpopulations of cells in the second cell population based on external classification and subpopulations in the second cell population identified based on the second reduced parameter data, and determining a third overall dissimilarity score based on the second set of dissimilarity scores.

In some embodiments, the method also includes displaying the two or more of the first overall dissimilarity score, second overall dissimilarity score, and third overall dissimilarity score on a graphical user interface.

In some embodiments, the method also includes comparing the two or more of the first overall dissimilarity score, second coverall dissimilarity score, and third overall dissimilarity score.

In some embodiments, identifying subpopulations of the second cell population and recognizing at least some of the subpopulations of the second cell population as corresponding to at least some of the subpopulation labels of cells in the first training cell population based on the second reduced parameter data includes one or more of: a) detecting clusters in the second reduced parameter data and determining a most similar median or mean of clusters between the subpopulations in the first training cell population and the detected clusters in the second reduced parameter data; b) detecting clusters in the second reduced parameter data and determining QFM dissimilarity scores on combinations of subpopulations in the first training cell population and the detected clusters in the second reduced parameter data; c) for each item in the second reduced parameter data, assigning the associated label of the item in the first training set that is closest to the item in the second reduced parameter data set; and d) for each item in the second reduced parameter data, assigning the associated label of the item in the first training set that is closest to the item in the second reduced parameter data set, detecting clusters in the second reduced parameter data and, for each cluster in the second reduced parameter data, determining a closeness of the cluster in the second reduced parameter data to a subpopulation in the first training data set based on a subpopulation label with a highest number of label assignments for each item in the second test data cluster.

In some embodiments, the method also includes: displaying two or more options for identifying subpopulations of the second cell population and recognizing at least some of the subpopulations of the second cell population as corresponding to at least some of the subpopulation labels of cells in the first training cell population based on the second reduced parameter data in a graphical user interface; and receiving a selection of at least one of the two or more options for identifying subpopulations of the second cell population and recognizing at least some of the subpopulations of the second cell population as corresponding to at least some of the subpopulation labels of cells in the first training cell population based on the second reduced parameter data.

In some embodiment of the method, identifying subpopulations of the second cell population and recognizing at least some of the subpopulations of the second cell population as corresponding to at least some of the subpopulation labels of cells in the first training cell population based on the second reduced parameter data includes employing density based merging to identify or confirm boundaries of the subpopulations in the second reduced parameter data. In some embodiments, the method also includes generating a quadrative form tree or phenogram of the subpopulations in the second cell population for visualization of relatedness between identified subpopulations.

In some embodiments, the reduced parameter data has two parameters or three parameters. In some embodiments, the reduced parameter data has more than three parameters.

In some embodiments, the method also includes prior to, during, or after performing template-guided uniform manifold approximation and projection on the second data employing the first reduced parameter data as template data to produce second reduced parameter data: determining whether the second data appears to include one or more subpopulations of cells that do not belong to any of the labeled subpopulations in the first training cell population; and where it is determined that the second data appears to include one or more subpopulations of cells that do not belong to any of the labeled subpopulations in the first training cell population, performing one or more of: providing a user a notification; presenting a user with option, via a graphical user interface, to select performance of an alternative to performance of the template-guided uniform manifold approximation and projection on the second data employing the first reduced parameter data as template data; and suspending, pausing, terminating or not initiating performance of the template-guided uniform manifold approximation and projection on the second data employing the first reduced parameter data as template data.

In some embodiments, where it is determined that the second data appears to include one or more subpopulations of cells that do not belong to any of the labeled subpopulations in the first training cell population, the method further also includes: upon receipt of a user selection, performing the alterative to performance of the template-guided uniform manifold approximation and projection on the second data employing the first reduced parameter data as template data, wherein the alternative comprises: performing a re-supervised reduction on the second test data that appears to correspond to one or more new subpopulations including generating supervising labels for the second test set and performing supervised UMAP on the second data using the generated supervising labels; or after performing supervised UMAP on the first training data, performing a joined transform method in which template-guided UMAP is modified such that both the first training data set and the second data set are used to determine the nearest neighbors of each point in the second data set, and such that that during stochastic gradient descent, and application of attractive and repulsive forces, the first training data points do not move as their position is considered already correctly determined, while the second test data points move.

In some embodiments, the first data comprises flow cytometry data.

In some embodiments, the first data comprises mass cytometry data.

In some embodiments, the method detects the presence of a rare disease relevant subset in the second data.

In some embodiments, the method also includes, based on a determination that the identification of subpopulations of the second cell population is accurate: obtaining or accessing third data including measurements of the plurality of parameters for cells in a third cell population; performing template-guided uniform manifold approximation and projection on the third data employing the first reduced parameter data corresponding to the first training cell population as template data to produce third reduced parameter data corresponding to measurements of the plurality of parameters of cells in the third cell population; and identifying subpopulations of the third cell population and recognizing at least some of the subpopulations of the third cell population as corresponding to at least some of the subpopulation labels of cells in the first training cell population based on the third reduced parameter data.

In some embodiments, the method identifies the presence of a rare disease relevant functional subpopulation of cells in the second cell population.

In some embodiments, the method identifies the absence of a disease relevant functional subpopulation of cells in the second cell population.

According to one aspect, the described invention provides a method for identifying subpopulations of items from high dimensional data regarding a population of items. The method includes obtaining or accessing first training data including values of a plurality of parameters for items in first training item population and including one of a plurality of subpopulation labels for each item in the first training item population, the plurality of parameters including more than five parameters, and the subpopulation labels identifying different subpopulations of items in the first training item population. The method also includes performing supervised uniform manifold approximation and projection on the first training data using the subpopulation labels for supervision to produce first reduced parameter data corresponding to the values of the plurality of parameters for the items in the first training item population in a reduced parameter dataspace. The method also includes obtaining or accessing second data including values of the plurality of parameters for items in a second item population. The method also includes performing template-guided uniform manifold approximation and projection on the second data employing the first reduced parameter data corresponding to the first training item population as template data to produce second reduced parameter data corresponding to values the plurality of parameters for items in the second item population. The method also includes identifying subpopulations of the second item population and recognizing at least some of the subpopulations of the second item population as corresponding to at least some of the subpopulation labels of items in the first training item population based on the second reduced parameter data.

In some embodiments, the method also includes applying quadrative form matching to the subpopulations for the first training item population and the identified subpopulations of the second item population based on the second reduced parameter data to determine the accuracy of the identification and recognition of subpopulations of the second item population as corresponding to subpopulations of the first training item population.

In some embodiments, applying the quadrative form matching to the subpopulations for the first training item population and the identified subpopulations of the second item population based on the second reduced parameter data to determine the accuracy of the identification and recognition of at least some of the subpopulations of the second item population as corresponding to subpopulations of the first training item population includes: determining a first set of dissimilarity scores for corresponding matching subpopulations between labeled subpopulations in the first training item population and subpopulations in the second item population identified based on the second reduced parameter data; and determining a first overall dissimilarity score based on the first set of dissimilarity scores.

In some embodiments, applying the quadrative form matching to the subpopulations for the first training item population and the identified subpopulations of the second item population based on the second reduced parameter data to determine the accuracy of the identification and recognition of at least some of the subpopulations of the second item population as corresponding to subpopulations of the first training item population includes two or more of: determining a first set of dissimilarity scores for corresponding matching subpopulations between labeled subpopulations in the first training item population and subpopulations in the second item population identified based on the second reduced parameter data, and determining a first overall dissimilarity score based on the first set of dissimilarity scores; determining a second set of dissimilarity scores for corresponding matching subpopulations between labeled subpopulations in the first training item population and subpopulations in the second item population identified based on obtained third data including subpopulation labels identifying different functional subpopulations of items in the second item population based on external classification, and determining a second overall dissimilarity score based on the second set of dissimilarity scores; and determining a third set of dissimilarity scores for corresponding matching subpopulations between subpopulations in the second item population identified based on obtained third data including subpopulation labels identifying different functional subpopulations of items in the second item population based on external classification and subpopulations in the second item population identified based on the second reduced parameter data, and determining a third overall dissimilarity score based on the second set of dissimilarity scores.

In some embodiments, the method also includes displaying the two or more of the first overall dissimilarity score, second overall dissimilarity score, and third overall dissimilarity score on a graphical user interface.

In some embodiments, the method also includes comparing the two or more of the first overall dissimilarity score, second coverall dissimilarity score, and third overall dissimilarity score.

In some embodiments, identifying subpopulations of the second item population and recognizing at least some of the subpopulations of the second item population as corresponding to at least some of the subpopulation labels of items in the first training item population based on the second reduced parameter data includes one or more of: a) detecting clusters in the second reduced parameter data and determining a most similar median or mean of clusters between the subpopulations in the first training item population and the detected clusters in the second reduced parameter data; b) detecting clusters in the second reduced parameter data and determining QFM dissimilarity scores on combinations of subpopulations in the first training item population and the detected clusters in the second reduced parameter data; c) for each item in the second reduced parameter data, assigning the associated label of the item in the first training set that is closest to the item in the second reduced parameter data set; and d) for each item in the second reduced parameter data, assigning the associated label of the item in the first training set that is closest to the item in the second reduced parameter data set, detecting clusters in the second reduced parameter data and, for each cluster in the second reduced parameter data, determining a closeness of the cluster in the second reduced parameter data to a subpopulation in the first training data set based on a subpopulation label with a highest number of label assignments for each item in the second test data cluster.

In some embodiments, the method further includes: displaying two or more options for identifying subpopulations of the second item population and recognizing at least some of the subpopulations of the second item population as corresponding to at least some of the subpopulation labels of items in the first training item population based on the second reduced parameter data in a graphical user interface; and receiving a selection of at least one of the two or more options for identifying subpopulations of the second item population and recognizing at least some of the subpopulations of the second item population as corresponding to at least some of the subpopulation labels of items in the first training item population based on the second reduced parameter data.

In some embodiments, identifying subpopulations of the second item population and recognizing at least some of the subpopulations of the second item population as corresponding to at least some of the subpopulation labels of items in the first training item population based on the second reduced parameter data comprises employing density based merging to identify or confirm boundaries of the subpopulations in the second reduced parameter data.

In some embodiments, the method also includes generating a quadrative form tree or phenogram of the subpopulations in the second item population for visualization of relatedness between identified subpopulations.

In some embodiments, the method includes, prior to, during, or after performing template-guided uniform manifold approximation and projection on the second data employing the first reduced parameter data as template data to produce second reduced parameter data: determining whether the second data appears to include one or more subpopulations of items that do not belong to any of the labeled subpopulations in the first training item population; and where it is determined that the second data appears to include one or more subpopulations of items that do not belong to any of the labeled subpopulations in the first training item population, performing one or more of: providing a user a notification; presenting a user with option, via a graphical user interface, to select performance of an alternative to performance of the template-guided uniform manifold approximation and projection on the second data employing the first reduced parameter data as template data; and suspending, pausing, terminating or not initiating performance of the template-guided uniform manifold approximation and projection on the second data employing the first reduced parameter data as template data.

In some embodiments, where it is determined that the second data appears to include one or more subpopulations of items that do not belong to any of the labeled subpopulations in the first training item population, the method also includes: upon receipt of a user selection, performing the alterative to performance of the template-guided uniform manifold approximation and projection on the second data employing the first reduced parameter data as template data, where the alternative comprises: performing a re-supervised reduction on the second test data that appears to correspond to one or more new subpopulations including generating supervising labels for the second test set and performing supervised UMAP on the second data using the generated supervising labels; or after performing supervised UMAP on the first training data, performing a joined transform method in which template-guided UMAP is modified such that both the first training data set and the second data set are used to determine the nearest neighbors of each point in the second data set, and such that that during stochastic gradient descent, and application of attractive and repulsive forces, the first training data points do not move as their position is considered already correctly determined, while the second test data points move.

In some embodiments, the method also includes, based on a determination that the identification of subpopulations of the second item population is accurate: obtaining or accessing third data including values of the plurality of parameters for items in a third item population; performing template-guided uniform manifold approximation and projection on the third data employing the first reduced parameter data corresponding to the first training item population as template data to produce third reduced parameter data corresponding to measurements of the plurality of parameters of items in the third item population; and identifying subpopulations of the third item population and recognizing at least some of the subpopulations of the third item population as corresponding to at least some of the subpopulation labels of items in the first training item population based on the third reduced parameter data.

According to one aspect, the described invention provides a system for identifying subpopulations of items from high dimensional data regarding a population of items. The system includes storage configured to hold: first training data including values of a plurality of parameters for items in first training item population and including one of a plurality of subpopulation labels for each item in the first training item population, the plurality of parameters including more than five parameters, and the subpopulation labels identifying different subpopulations of items in the first training item population; and second data including values of the plurality of parameters for items in a second item population. The system also includes one or more processors in communication with the storage and configured to execute instructions comprising instructions to: perform supervised uniform manifold approximation and projection on the first training data using the subpopulation labels for supervision to produce first reduced parameter data corresponding to the values of the plurality of parameters for the items in the first training item population in a reduced parameter dataspace; perform template-guided uniform manifold approximation and projection on the second data employing the first reduced parameter data corresponding to the first training item population as template data to produce second reduced parameter data corresponding to values the plurality of parameters for items in the second item population; and identify subpopulations of the second item population and recognize at least some of the subpopulations of the second item population corresponding to at least some of the subpopulation labels of items in the first training item population based on the second reduced parameter data.

According to one aspect, the described invention provides a non-transitory computer readable medium including instructions that when executed by one or more processors to cause a computing device or system to perform any of the methods recited or claimed herein.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 schematically depicts a method for determining relevant subsets of high dimensional data and accuracy of the assigned subsets in accordance with an embodiment;

FIG. 2 schematically depicts a high-dimensional optimization in basic UMAP;

FIG. 3 schematically depicts a low-dimensional optimization in basic UMAP;

FIG. 4A schematically depicts a high-dimensional optimization in supervised UMAP;

FIG. 4B schematically depicts a low-dimensional optimization in supervised UMAP;

FIG. 5A schematically depicts a high-dimensional optimization in template-guided UMAP;

FIG. 5B schematically depicts a low-dimensional optimization in template-guided UMAP;

FIG. 6 is a schematic representation of a system including a computing system and an apparatus for obtaining experimental data in accordance with some embodiments;

FIG. 7A schematically depicts a distributed computing system in accordance with some embodiments;

FIG. 7B schematically depicts a UMAP Supervised Template (UST) system including modules in accordance with some embodiments;

FIG. 8 schematically depicts a computing device that may be used to implement some embodiments;

FIG. 9 includes graphs showing the initial gating to identify cell populations in Example 1;

FIG. 10A is a graph of results of unsupervised UMAP on a Balb/c sample of Example 1 for comparison;

FIG. 10B is a graph of results of supervised UMAP for the Balb/c sample of Example 1 indicating subdivisions in cell populations that has the same supervising label;

FIG. 11A is a graph of the supervised UMAP on the Balb/c sample used as a training sample in Example 1;

FIG. 11B is a graph of the result of supervised template guided UMAP on a RAGE sample, where the supervised template was generated from the Balb/c sample, in Example 1;

FIG. 12A is a graph showing the result of density based merging cluster detection on the result of supervised UMAP for the Balb/c sample training data in Example 1;

FIG. 12B is a graph showing the result of the density based merging cluster detection on the result of supervised template based UMAP for the RAG sample data in Example 1;

FIG. 13A is a QF-tree phenogram visualization for the classified subsets in the Balb/c sample in Example 1;

FIG. 13B is a QF-tree phenogram visualization for the identified subsets in the RAG sample in Example 1;

FIG. 14 includes histograms of matched pairs between training sets and tests sets for determining the accuracy of the subset determination in Example 1 in which the Y axis counts how many subsets in the training set have a particular level of dissimilarity with the subsets in the test set (e.g., frequency) and bins on the x-axis correspond to percentage dissimilarity between groups (e.g., pairs) of matched subsets, subpopulations or groupings in the training set and the test set;

FIG. 15A is a graph of supervised UMAP performed on the RAG sample in Example 1 with the RAG sample acting as training data;

FIG. 15B is an image of user interface warning to a user that the data to be reduced seems to include more subsets than the training data used to generate the supervised template in Example 1;

FIG. 15C is a graph of supervised template-guided UMAP based on the RAG sample supervised template performed on the Balb/c sample in Example 1;

FIG. 15D is the graph of FIG. 15C highlighted with results from manual gating for comparison in Example 1;

FIG. 15E is a graph of the result of supervised template-guided UMAP on the Balb/c sample when the supervised template for the RAG sample was resupervised with SDU distance in Example 1;

FIG. 15F is the graph of the results of FIG. 15E with cell highlighting from known subsets for clarification in Example 1;

FIG. 16A includes graphs showing the initial gating to identify cell populations in Example 2;

FIG. 16B is a graph of the result of supervised UMAP on sample 1 used as a training sample in Example 2;

FIG. 16C is a graph of the result of supervised template-guided UMAP on sample 2 after further processing by Density Based Merging (DBM) and Quadratic Form Matching (QFM) in Example 2;

FIG. 17A is a QF-tree phenogram visualization for the classified subsets in the training sample 1 in Example 2;

FIG. 17B is a QF-tree phenogram visualization for the supervised template-guided UMAP identified subsets in sample 2 in Example 2;

FIG. 18 includes graphs for determining or verifying the accuracy of the subset determination via supervised template-guided UMAP of sample 2 data in Example 2;

FIG. 19A includes graphs showing the initial gating to identify cell populations in Example 3;

FIG. 19B is a graph of the result of supervised UMAP on sample 1 in Example 3;

FIG. 19C is a graph of the result of supervised template guided UMAP on sample 2 after further processing by DBM and QFM in Example 3;

FIG. 20A is a QF-Tree phenogram visualization for the classified subsets in the training sample 1 in Example 3;

FIG. 20B is a QF-Tree phenogram visualization for the identified subsets in the supervised template-guided UMAP results for sample 2 in Example 3;

FIG. 21 includes graphs for determining the accuracy of the subset determination in Example 3

FIG. 22A includes graphs showing the initial gating to identify cell populations in Example 4;

FIG. 22B is a graph of the result of supervised UMAP on sample 1 in Example 4;

FIG. 22C is a graph of the result of supervised template guided UMAP on sample 2 after further processing by DBM and QFM in Example 4;

FIG. 23A is a QF-tree phenogram visualization for the classified subsets in the training sample 1 in Example 4;

FIG. 23B is a QF-tree phenogram visualization for the identified subsets in sample 2 in Example 4;

FIG. 24 includes graphs of dissimilarity scores for determining/confirming the accuracy of the subset determination in Example 4;

FIG. 25A includes graphs showing gating of cells in Example 5;

FIG. 25B is a graph of the results of applying supervised UMAP to data from measurements of training cells from a CRS nasal tissue sample in Example 5;

FIG. 25C is a graph of the results of applying supervised template guided UMAP to data from measurement of cells from a sample of normal nasal tissue in Example 5; and

FIG. 25D is a graph of the results of applying supervised template guided UMAP to data from measurements of cells in matching peripheral blood in Example 5.

### DETAILED DESCRIPTION OF THE INVENTION

### Definitions

As used herein, the term “an item” is something that is subjected to measurement to yield data regarding multiple different parameters corresponding to different dimensions in a dataset or that has multiple different values for parameters associated with it that correspond to different dimensions in a dataset. In some embodiments, “an item” refers to an individual particle (e.g., including a cell or a group of cells), which is subjected to measurements in a flow cytometry system to produce multidimensional data. Examples of resulting measured data for the item, include, but are not limited to, optical scattering measurements and florescence measurements corresponding to different markers or staining for flow cytometry, and mass cytometry measurements.

The term “gating” as used herein refers to identification of a homogenous subpopulation, or relatively homogeneous subpopulation, of items (e.g., cells corresponding to one type) out of a larger set of items (e.g., cells of different types). A “gate” as used herein refers to a selection in one or more dimensions (corresponding to one or more measured parameters) of a subset of items from a larger set of items. For example, gating in the form of a gate or multiple gates may be used to distinguish one type of cells from other types of cells based on data from a flow cytometry system. Conventionally, two-dimensional gates are often used for analysis of flow cytometry data. Gates may be imposed sequentially, such that a subset of items resulting from a prior gate in one or more dimensions (corresponding to one or more measured parameters for the items) is used when determining a further gate in one or more other dimensions (corresponding to one or more other parameters for the items). For example, data corresponding to cells may initially be gated in two dimensions, with data corresponding to cells falling within the gate being used for further gating in other dimensions. Thus, a sequence of two-dimensional gates can be used to identify subpopulations of items (e.g., subpopulations of cells) from a multivariate data set including data for a larger plurality of items (e.g., larger group of cells).

The term “marker” as used herein refers to a structure that is associated with a cell or particle and is detectable because it emits a signal including, but not limited to, fluorescence, that can be measured by a detection instrument or because it is reactive with a reagent that emits such a signal or causes the emission of such a signal.

The term “reagent” as used herein refers to a substance used in a chemical reaction to detect, measure, examine, or produce other substances. Reagents include, but are not limited to, a dye, an antibody, a fluorophores, and a chromophore.

The term “stain” as used herein refers to a composition of a dye(s) or pigment(s) used to make a structure, a material, a cell, a cell component, a membrane, a granule, a nucleus, a cell surface receptor, a peptide, a microorganism, a nucleic acid, a protein or a tissue distinguishable. The term “staining reagent” and, unless otherwise defined, the term “reagent” as used herein are synonymous with the term “stain.”

Unless defined otherwise, all technical terms used herein have the same meaning as commonly understood by one of skill in the art to which this disclosed subject matter belongs. Any methods and materials similar or equivalent to those described herein also can be used in the practice of or testing utilizing of the presently disclosed subject matter.

It must be noted that as used herein and in the appended claims, the singular forms “a”, “and”, and “the” include plural references unless the context clearly dictates otherwise.

Reference in the present specification to “one embodiment” or “an embodiment” means that a particular feature, structure, or characteristic described in connection with the embodiment is included in at least one embodiment of the invention. The appearances of the phrase “in one embodiment” or “an embodiment” in various places in the specification do not necessarily all refer to the same embodiment.

Some embodiments enable efficient and accurate application of classifications of subsets of a population from a training set to a test set without rerunning the classification, and confirmation or verification of the accuracy of the classification applied to the test set. For example, in cytometry where gating is traditionally used to classify subsets of cells, some embodiments enable the application of results of gating in a training set of cell classification data to compatible samples without re-running the gating for the compatible samples. This greatly increases the efficiency of classification for flow cytometry data.

Embodiments employ the topology and category theory math underlying Uniform Manifold Approximation and Projection (UMAP) for parameter reduction to aid in identifying relevant subsets of items from high dimensional data regarding a population of items. For example, in some embodiments, topology and category theory match underlying UMAP may be employed for recognizing and apply gating patterns for flow cytometry data. UMAP defines subsets using parameter reduction. Parameter reduction involves reducing higher dimensional data into lower dimensional data. One purpose of reduction is to see the similarity of things represented by a number of dimensions that are too high to visualize. An example practiced in immune-cytometry would be taking 100,000 lymphocyte cells with 30 biomarker measurements each and using parameter reduction to translate cell similarity in 30-dimensional space into cell proximity on a 2 or 3 dimensional plot. This reduction in the dimensional space enables more straightforward identification of similar cells because the closer cells are to each other on the X/Y plot (or X/Y/Z plot) the more similar they are to each other in terms of their 30 measurements. Embodiments employ supervised template-guided UMAP to efficiently apply knowledge regarding subsets in a template sample to aid in efficient and accurate identification of corresponding subsets in an unclassified sample.

The topological theory underlying UMAP's reduction is robust against the perturbations that happen in the high dimensional space particularly in domains like flow cytometry measurements of lymphocyte data. Perturbations include dramatic variations in expected frequencies of cell types, instrument/spectral noise, sample noise like extraneous “crud” in the biological matter or data to the matter, systemic shifts in the data due to intentional differences in instrument configuration or staining of the samples. Working on the low dimensional space also is more efficient when running follow up metrics on the data to explore and characterize further the detected subsets.

Some embodiments also employ cluster identification in the reduced dimensional space to identify clusters of the reduced dimensional data. The cluster identification may include density based merging.

Embodiments also employ quadratic form matching to a sample with known subsets to determine the accuracy of the subsets determined via supervised template-guided UMAP.

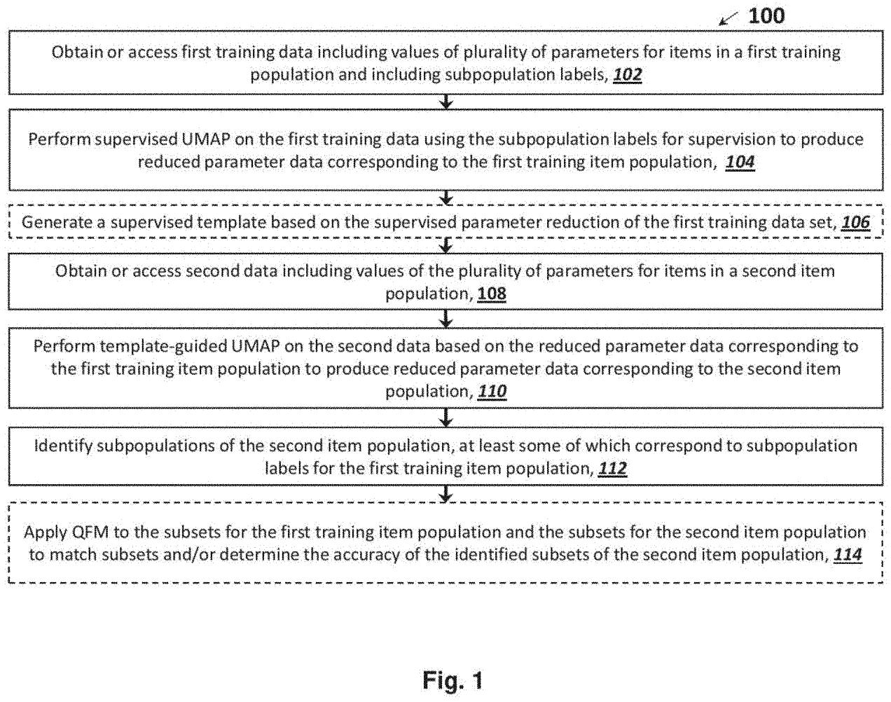

FIG. 1 is a flow diagram of a method 100 for identifying subsets of items (e.g., particles, cells, cell components, etc.) from high dimensional data regarding a population of items. In some embodiments the method 100 also includes characterizing and verifying the accuracy of the identified subsets in accordance with some embodiments. In some embodiments, the method may be a method for identifying distributions of subpopulations of items (e.g., cells) and verifying the accuracy of the identified subpopulations in accordance with an embodiment. Although some figures and accompanying description address an embodiment in which the items are cells in a cell population, the method may be applied to other populations of items or to other types of multi-parameter data that can be grouped into sets and subsets or subpopulations. For example, another embodiments may be directed to census data or demographic data where the “items” are people.

In method 100, first training data including values of a plurality of parameters of items in a first training item population and including one of a plurality of subpopulation labels for each item in the first training item population is obtained 102. These labels may also, or alternatively be referred to a classification labels. With respect to the first training item population, the labels may also, or alternatively, be referred to as supervisor labels for classification. In some embodiments, the items are cells, the first training data includes measurements of a plurality of parameters of cells in a first training cell population and includes one of a plurality of subpopulation labels for each cell in the first training cell population. In some embodiments in which the data is cytometry data, the first training data may be from a representative sample, multiple representative samples, or one or more representative samples spiked with synthetic data to represent predicted subsets. In some embodiments, the plurality of parameters comprises at least five parameters, and the subpopulation labels identify and classify different subpopulations of items in the first training item population. In some embodiments, the subpopulation labels identify different functional subpopulations of cells in the first training cell population. In other embodiments, subpopulation labels or subset labels may indicate other types, identifications or groupings for the subsets or subpopulations of items. In some embodiments, the first training data includes a two dimensional array in which each row corresponds to an item and each column holds a value for a variable for that item (e.g., a measurement of the item) in the original (higher) dimensional space, and includes a one dimensional array that holds a classification label, which may be a subset or subpopulation label, for each item. In other embodiments, the first training data may be provided in other forms or in other data structures as would be appreciated by one of ordinary skill in the art in view of the present disclosure. For example, in some embodiments, a single data structure may include both the measurements and the subpopulation identifier for each item.

Supervised uniform manifold approximation and projection (UMAP) is performed on the first training data using the subpopulation labels, also known as supervisor labels or classification labels, for supervision to produce reduced parameter data corresponding to the first training item population 104. This reduced parameter data can be described as a low dimensional embedding of the first training item population data. In some embodiments, supervised UMAP is performed on the first training data for a first training cell population using the labels identifying different functional subpopulations for supervision to produce reduced parameter data corresponding to the first training cell population. In some embodiments, the reduced parameter data has two parameters or three parameters. In other embodiments, the reduced parameter data has more than three parameters.

In some embodiments, the resulting reduced parameter training data from supervision, which may be referred to herein as supervision-produced reduced parameter training data or reduce parameter second training data, includes a data structure (e.g., an array) having an index (e.g., a row) identifying each item and columns corresponding to values for each of the reduced variables for that item. In some embodiments, a separate data structure includes the subpopulation label, also known as the classification label or supervisor label, for each training item. In other embodiments, the subpopulation label for each training item may be stored in the same data structure as the values for the reduced parameter data. In some embodiments, the output of supervised UMAP performed on the first training data using the subpopulation labels for supervision is an instance of an object in an object oriented programming language (e.g., an instance of python language object, a MatLab object, etc.).

In some embodiments, a supervised template is generated based on the supervised parameter reduction of the first training data 106. The box for 106 being in broken lines in FIG. 1 indicates that this step may not be performed in all embodiments. In some embodiments, the supervised template is a binary persistence of elements of an object corresponding to the output of supervised UMAP, which may be referred to as a UMAP object. This supervised UMAP may be performed using the computer implementation described in Appendices A and B of the provisional application from which this application claims priority, which is incorporated herein by reference in its entirety. In some embodiments a supervised template is generated based on the supervised parameter reduction of the first training data for the first training population 136. In some embodiments, the supervised template may be generated using the computer implementation described in Appendix B of the provisional application from which this application claims priority, which is incorporated herein by reference in its entirety.

Second data including values of the plurality of parameters for items in a second item population is obtained or accessed 108. In some embodiments, the second data includes measurements of the plurality of parameters for cells in a second cell population. The second data, which is not used for training, may be referred to as sample data, test data or unclassified data herein. The second data should be compatible with the first training data, which means, at least, that the second data should have values for the same parameters as those of the first training data. The first training population of items must also be similar to the second population of items in general type (e.g., cells, particles, people, etc.).

The supervision-produced reduced parameter training data is used as input template data for template-guided UMAP parameter reduction of the second data. Because the template-guided UMAP parameter reduction is based on supervision-produced reduced parameter training data, performing the template-guided UMAP reduction of the second data can be described as performing supervised template-guided UMAP parameter reduction on the second data by transforming the second data based on the results of the supervised UMAP that was performed on the first training data to produce reduced parameter data corresponding to the second data 110. In embodiments where a supervised template was generated, the supervised template can be used for the supervised template-guided UMAP parameter reduction performed on the second data.

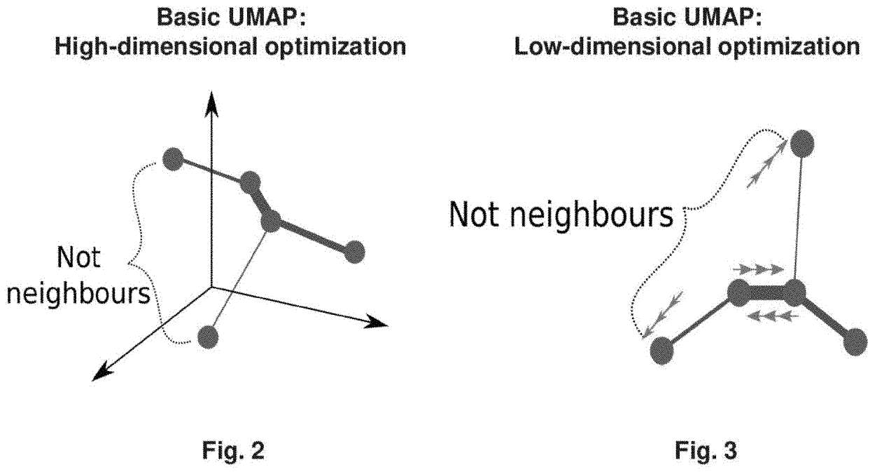

An explanation of various aspects of UMAP, supervised UMAP and supervised template-guided UMAP is presented below in connection with FIGS. 2-5. Additional details and information regarding parameter reduction and subset identification using UMAP can be found in McInnes, Leland and Healy, John and Saul, Nathaniel and Grossberger, Lukas, UMAP: Uniform Manifold Approximation and Projection, The Journal of Open Source Software, 3(29):861, 2018; McInnes, L., Healy, J., and Melville, J., UMAP: Uniform Manifold Approximation and Projection for Dimension Reduction, ArXiv e-prints 1802.03426 [stat.ML], Dec. 6, 2018, and in the online user guide and tutorial for UMAP available at umap-learnreadthedocs.io/en/latest Revision 94f26f11 by Leland McInnes, each of which is incorporated by reference herein in its entirety. Software for implementing UMAP is available on at github.com/lmcinnes/umap. Additional explanation regarding how UMAP works is available in the document “How UMAP Works” available from umap-learn.readthedocs.io/en/latest/how_umap_works.html and is included in Appendix A of the provisional application from which this application claims priority, which is incorporated herein by reference in its entirety. Additional explanation regarding UMAP parameters available in the document “Basic UMAP Parameters” from umap-learn.readthedocs.io/en/latest/parameters.html, and is also included in Appendix A of the provisional application from which this application claims priority. Additional explanation of supervised UMAP is available in the document “UMAP for Supervised Dimension Reduction and Metric learning” from umap-learn.readthedocs.io/en/latest/supervised.html and is also included in Appendix A of the provisional application from which this application claims priority. Additional explanation of how to conduct template guided parameter reduction is available in the document “Transforming New Data with UMAP” from umap-learn.readthedocs.io/en/latest/transform.html and is also included in Appendix A of the provisional application from which this application claims priority. Additional information regarding using UMAP for clustering is available in the document “Using UMAP for Clustering” from umap-learnseadthedocs.io/en/latest/clustering.html and is also included in Appendix A of the provisional application from which this application claims priority.

The inventors have also created their own modified implementation of UMAP for the MATLAB scientific computing environment. See Connor Meehan, Stephen Meehan, and Wayne Moore (2020). Uniform Manifold Approximation and Projection (UMAP) (www.mathworks.com/matlabcentral/fileexchange/71902), MATLAB Central File Exchange. In addition to the original functionality of UMAP, the inventors included additional functionality to detect clusters or subsets in the low-dimensional output of UMAP, as well as to produce cluster IDs or subset IDs. The inventors also added the ability to match new clusters or subsets to old supervisor clusters or subsets using quadratic form matching in the case that test data is transformed using a template created by supervised dimension reduction (e.g., in the case that supervised template-guided UMAP is performed). The overall description of the modified implementation and new functionality and a listing of all functions is included in Appendix B of the provisional application from which this application claims priority, which is incorporated herein by reference in its entirety.

UMAP includes three different kinds of parameter reduction: basic parameter reduction, supervised parameter reduction, and template-guided parameter reduction. Basic UMAP parameter reduction reduces data without subpopulation labels. In the immune-cytometry example mentioned above, basic parameter reduction would be reduction based only on each cell's 30 biomarker measurements. FIG. 2 illustrates high-dimensional optimization for basic parameter reduction. In high dimension (HiD), which refers to five dimensions or more, UMAP builds a k-nearest neighbor graph among data points. UMAP assigns weights among pairs in the k-nearest neighbor graph according to how close points are in HiD. FIG. 3 illustrates low-dimensional optimization for basic parameter reduction. UMAP places points into low dimension (LowD) space (e.g., 2-D or 3D space) and optimizes the embedding through gradient descent. This optimization of the embedding is based on minimizing or reducing cross-entropy, as explained in further detail below. As illustrated in FIG. 3, every pair of neighboring points push and pull on each other and every pair of non-neighboring point push on each other: the heavier the edge between them illustrated by the thickness of the line connecting them, the more they pull together, the lighter the edge between them, the more they push apart. Considering the push of every pair of non-neighboring points on each other is very computationally expensive. In some embodiments, to speed computation, the pull of every pair of neighboring points on each other is considered, and every time a pull is applied, pushes are applied to randomly sampled pairs, as described in more detail below.

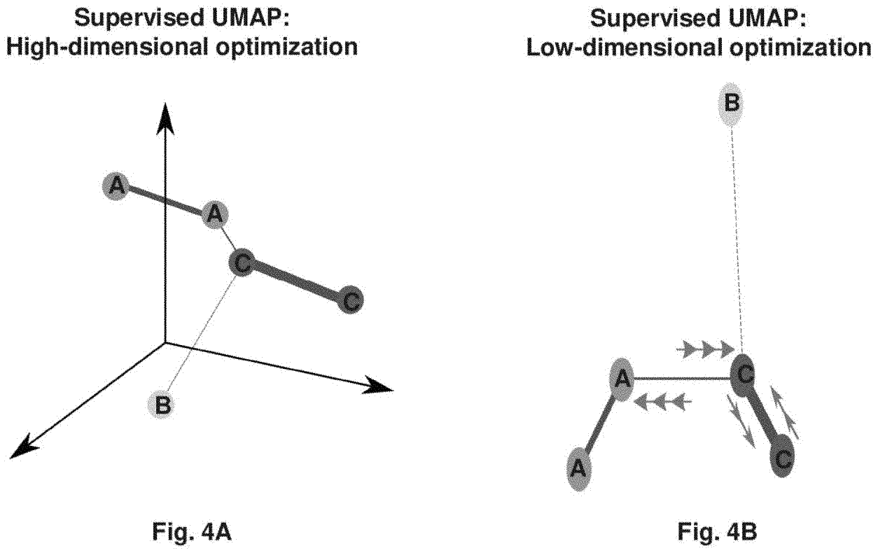

Supervised UMAP is similar to basic UMAP, but it also uses labels assigned to items, which may be referred to as supervisor labels or classification labels, for the parameter reduction. In the immune-cytometry example, the 30 dimensional biomarker data is reduced based in part on a label for each cell that identifies what type of lymphocyte the cell is known to be (e.g., a T cell, a B cell, a macrophage), which is the subpopulation to which the cell belongs. The identification of the type that is used for the label can be based on any external classification method or knowledge. For the lymphocyte example above, the labels for the lymphocyte type for the cells may be based on manual gating, automated gating, semi-automated gating, cluster analysis, etc. In supervised UMAP, when considering cross-entropy, attractive forces, and repulsive forces between points, points having different data supervisor labels have their edge weights significantly reduced. In FIGS. 4A and 4B, letters are used to indicate different labels. FIG. 4A illustrates how the weighting for HiD optimization is modified based on the data labels in supervised UMAP. FIG. 4B illustrates how the weighting affects the push and pull on pairs in the low-dimensional optimization in supervised UMAP. Close points with different labels mostly push on each other, but still pull a little bit.

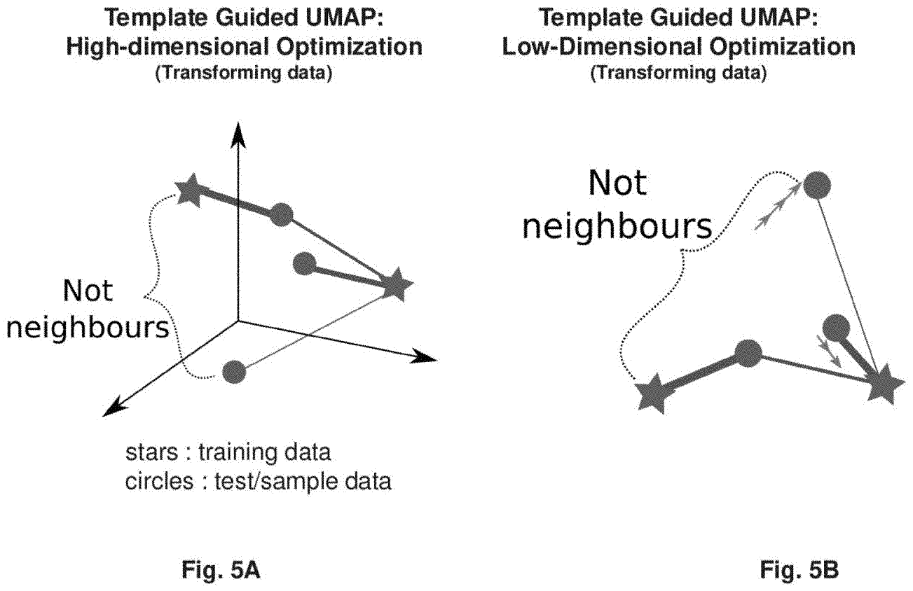

Template-guided UMAP is similar to basic UMAP except that it uses the outcome of a prior parameter reduction on different data to guide parameter reduction on new data. In template-guided UMAP, the neighbor graph is only drawn from the test data to the training data and labels for the training data, if any, are not used in the parameter reduction. This is illustrated for high-dimensional optimization in FIG. 5A where the stars indicate training data and the circles indicate test or sample data. The pre-established training helps transform the new data into low dimensional data (e.g., 2D or 3D). The low dimensional optimization only pushes and pulls the new test/sample data. This is illustrated for low-dimensional optimization in FIG. 5B.

Supervised template-guided UMAP as employed and described herein involves performing supervised UMAP on training data with classification labels for parameter reduction, and then using the resulting reduced parameter training data in template-guided UMAP performed on a different set of test data or sample data that need not include any classification labels. For the lymphocyte example above, this would involve performing supervised UMAP on training data from a training population of lymphocytes including labels identifying the known lymphocyte type for each cell for parameter reduction to obtain a supervised template in the form of the reduced parameter training data, and then performing template-guided UMAP of a new data set including the same 60 biomarker measurements for a new population of lymphocytes to perform parameter reduction. The template-guided UMAP would employ the reduced parameter training data from performing supervised UMAP on the training data as the template for the template-guided UMAP of the new data set.

As noted above, generally speaking, UMAP can be described as seeking to minimize cross-entropy. Cross-entropy measures the difference between high and low dimensional embeddings. The best low dimensional embedding should minimize cross-entropy, which can be described using the following equation:

$${\sum }_{e ∈ \{ all pairs )} {w}_{h} ( e ) log ( {w}_{l} ( e ) ) + ( 1 - {w}_{h} ( e ) ) log ( 1 - {w}_{l} ( e ) )$$

where wₕ is the edge weight in hiD, wₗ is the edge weight in lowD (e.g., 2-D). The first term wₕ (e) log (wₗ (e)) represents attractive forces, and the second term (1−wₕ (e)) log (1−wₗ (e)) represents repulsive forces. If there is no edge between two points then wₕ (e)=0 for that pair. If there are N data points, there are at most k*N attractive forces where k is the number of nearest neighbors, but about 0.5*N² repulsive forces, which is too many terms to calculate and maintain a reasonable processing time. The number of nearest neighbors k is a selected parameter that may be modified or defined by a user in some embodiments. In other embodiments, the value of the parameter k may be fixed.

To address the problems with the large number of terms in the cross-entropy equation, in some embodiments, UMAP employs negative sampling instead of cross-entropy. Generally speaking, in negative sampling, each time an attractive force is applied, repulsive forces are randomly selected for sampling. Negative sampling seeks to minimize the following:

$${\sum }_{( i , j ) ∈ \{ k - N N g r a p h )} {w}_{h} ( {e}_{i j} ) ( log ( {w}_{l} ( {e}_{i j} ) ) + {\sum }_{m = 1}^{M} log ( 1 - {w}_{l} ( {e}_{i {j}_{m}} ) ) )$$

where M is the negative sampling rate or number of negative samples as defined by a selected parameter that may be modified or defined by a user in some embodiments. In other embodiments, the value of the parameter M may be fixed. The first term wₕ (e_{i,j}) log (wₗ (e_{i,j})) still represents the same attractive forces, but in the second term wₕ (e_{i,j}) Σₘ₌₁^{M} log (1−wₗ(e_{i,j}_{ₘ})), the j₁, . . . jₘ are randomly selected for application of the repulsive forces. This no longer strictly minimizes cross-entropy, but the dimension reduction done with this method shows good results without being computationally unmanageable.

Turning again to FIG. 1, method 100 also includes identifying subpopulations of the second item population, at least some of the subpopulations in the second item population corresponding to subpopulation labels applied to the first training item population 112. In some embodiments, the first items and second items are cells (e.g., lymphocytes) and the subpopulations of the second item population are types of cells (e.g., types of lymphocytes). In some embodiments, the subpopulations of the second item populations are different functional subpopulations of cells.

When doing any type of parameter reduction, UMAP performs much of the work of identifying subsets and classification by structuring the input data into data islands that make it easy for almost any clustering method to identify subsets or subpopulations as being points in the low D space that “clump” together. Supervised UMAP computes closeness in terms of both the topological characteristics of the unreduced parameters (e.g., measurements) of the input data as well as the common external classification labels for the input data. Thus, performing supervised UMAP increases the speed and efficiency of additional analysis and processing for data corresponding to items. Additional methods are used after performing UMAP, either supervised UMAP or template-guided UMAP, to identify subsets, subpopulations, or groups in the reduced parameter data. When no supervisory labels are involved in the reduction (e.g., for template-based UMAP), density-based clustering can be employed to do the UMAP-simplified job of confirming “data island shores” or “clump borders” for subsets, subpopulations, or groupings in some embodiments. In some embodiments, the density clustering method is density-based merging (DBM). Further information regarding DBM may be found in U.S. Patent Application Publication No. 2019/0050408 entitled “Method for Identifying Clusters of Fluorescence-Activated Cell Sorting Data Points”, in Guenther, W. et al., Automatic Clustering of Flow Cytometry Data with Density-Based Merging, Advances in Bioinformatics, vol. 2009, Article ID 686759 (2009), and in Meehan, S., Kolyagin, G. A., Parks, D. et al. Automated subset identification and characterization pipeline for multidimensional flow and mass cytometry data clustering and visualization, Commun Biol 2, 229 (2019) (Supplementary Materials “Updated DBM clustering algorithm” section), each of which is incorporated herein by reference in its entirety. Other density based clustering methods may be employed, as described below.

When supervisory labels are involved in UMAP's reduction (e.g., for supervised UMAP), subsets are identified through a recognition method, which identifies previously known subsets corresponding to subsets in supervising or training data set, further subset divisions of previously known subsets in the supervising or training data set, and new subsets not corresponding to any subsets in the supervising or training subset.

As noted above, in some embodiments, clustering is employed for determining subsets, subpopulations, or groupings in the second item population. In some embodiments, clustering may include density based merging, or other known clustering methods such as density-based spatial clustering of applications with noise (DBSCAN) algorithms or methods or SWIFT Scalable Weighted Iterative Flow-Clustering Technique software available online from the Mosmann Lab at the University of Rochester Medical Center. As noted above, in some embodiments, density based merging is employed to determine or confirm boundaries of the subsets or subpopulations in the reduced parameter data for the second item population. In some embodiments, the density based merging may be performed using the computer implementation described in Appendix B of the provisional application to which this application claims priority. In some embodiments, determination of subpopulations or clusters in the second item population may also performed in the original unreduced parameter dataspace to confirm that determination of subpopulations or clusters in the second item population is correct. In other embodiments, one or more other methods are employed to determine clusters and/or to classify items. In some embodiments, no clustering is performed and instead determination of subsets, subpopulations, or groupings and classification of items is done by matching each item in the second item subset/population with its nearest neighbor item in the first training population in the reduced parameter dataspace (e.g. the reduced dimensional space), and then assigning the subset/subpopulation classification label for the matching item in the first training population to the item in the second testing population. In some embodiments, determination of subpopulations and classification of items is done by matching each item in the second item population with its nearest neighbor item in the first training population in the original unreduced parameter dataspace (e.g., the original higher dimensional space), and then assigning the subpopulation label for the matching item in the first training population to the item in the second testing item population.

In some embodiments, subset matching is employed to match subsets, which are also referred to herein as subpopulations or groupings, in the reduced parameter data of the first training item population to corresponding subsets/subpopulations/groupings in the reduced parameter data of the second training item population. As used herein, subsets in the second item population (the non-training population) identified from the low-D supervised template-guided UMAP data (e.g., via clustering, item matching, or both) may be referred to as the UMAP Supervised Template (UST) subsets or subpopulations. The subsets of the second item population correspond to at least some of the subpopulation labels applied to the first training item population. In some embodiments, the method identifies subsets of the second item population corresponding to each subpopulation label or classification label in the first training item population, where present in the second item population. For example, in some embodiments the second item population may not include all of the subpopulations that are labeled in the first training item population. In some embodiments, the method includes identifying subsets of the second item population corresponding to each subpopulation label in the first training item population where present in the second item population, even when the method includes further subdividing a subpopulation in the second item population that is indicated with a single label in the first training item population. For example, in some embodiments, multiple different subdivisions of an identified subset in the second item population may correspond to a subpopulation identified with a single label in the first training item population. In some embodiments in which the first training population and the second population are cells, subpopulations of the second cell population, which may be referred to as subsets herein, correspond to at least some of the subpopulation labels applied to the first training cell population. For example, some subpopulations of the first training cell population may not have corresponding subpopulations in the second cell population.

Various methods and techniques may be employed to match subsets or subpopulations in second test/supervised item population to corresponding subsets or subpopulations in the first training item population. In some embodiments, each subset identified for the second test/supervised item population is assigned the label of the closest subset found in the supervised UMAP reduced parameter output for the first training/supervising population where closeness is based on Euclidean distance in the reduced dimensional space.

In some embodiments, the method includes recognition of previously known subsets, subpopulations, or groupings (e.g., those corresponding to subsets with classification labels in the first training data), where present, in the reduced second data or in the second data. In some embodiments, the method includes recognition of previously known subsets/subpopulations/groupings, further subset divisions of previously known subsets/subpopulations/groupings, and new subsets/subpopulations/groupings (e.g., those not corresponding to any classified subsets in the training data), where present, in the reduced second data or in the second data. Recognizing previously known or prior subsets/subpopulations/groupings can be performed by one of the following methods in some embodiments:

(a) most similar median/mean of clusters between data sets;

(b) QFM dissimilarity scores on cluster combinations between data sets;

(c) assigning the associated supervisor label of the item in the training set that is closest to each item in the test set regardless of cluster grouping, if any; and

(d) closeness of a cluster in the test set to a cluster in the training set based on the highest number of supervisory label assignments done by method (c) for each item in the test set cluster.

For method (c) the type of space used for closeness is Euclidean in some embodiments. In other embodiments, a different type of space can be used to evaluate closeness for method (c). Examples of other spaces include, but are not limited to, Mahalanobis, cityblock (AKA Manhattan), angular (AKA cosine), Minkowsk, and squared Euclidean in some embodiments. When the method for recognizing previously known or prior subsets includes clustering (e.g., methods (a), (b), and (d), the method not only recognizes previously known subsets, it also determines subsets/subpopulations/groupings that are: i) further subsets (sub divisions) of known subsets, ii) new and not seen in the training set; and iii) new subsets that match clusters in the low D reduction of the training set that had no external associated classification label, where present.

In some embodiments, the method includes receiving input from a user regarding which method to employ for recognizing previously known or prior subsets in the second data. In some embodiments, the method includes providing a user with a graphical user interface presenting options for methods to employ for recognizing previously known or prior subsets in the second data and receiving input from a user including a selection of one of the presented options.

In some embodiments, Quadratic Form Matching (QFM) is applied to the subsets or subpopulations in the reduced parameter data corresponding to the first training data and the subsets, subpopulations, or groupings in the reduced parameter data corresponding to the second data to identify subsets, subpopulations, or groupings of the second test item population and match them to subsets or subpopulations of the first test item population.

Some embodiments described herein employ a dissimilarity score that incorporates a form of the quadratic form (QF) distance measure to match subsets, subpopulations, or groupings present in multiple sets or populations, which is referred to as quadratic form matching (QFM), or to determine a degree or accuracy of matching between identified matched subsets in a first data set and in a second data set. In some embodiments, the QFM method accommodates data sets or populations where the location of a subset or subpopulation varies significantly from data set/population to data set/population in a Low-D representation, or when subsets or subpopulations disappear or appear between data sets or populations.

The QF distance is a metric that quantifies the dissimilarity between any two univariate histograms. It takes into account both differences in location as well as in frequencies at given locations. The inventors employ a method that extends the QF distance metric to the multivariate case and apply it to subset/subpopulation/cluster matching (e.g., for flow/mass cytometry data).

Various aspects of QFM and determinations of dissimilarity scores are described in U.S. Pat. No. 10,685,045 entitled “Systems and Methods for Cluster Matching Across Samples and Guided Visualization of Multidimensional Cytometry Data”, which is incorporated by reference herein in its entirety. Quadratic form matching is also described in Orlova, D. Y., Meehan, S., Parks, D., et al. QFMatch: multidimensional flow and mass cytometry samples alignment. Scientific Reports 2018; 8(1):3291. Published 2018 Feb. 19. doi:10.1038/s41598-018-21444-4, which is also incorporated by reference herein in its entirety.

In some embodiments, QFM is performed to match one or more identified subsets, subpopulations, or groupings in a first data set one or more identified subsets, subpopulations or groupings in a second data set. In some embodiments, the subsets, subpopulations, or groupings may have been previously identified via clustering methods. In some embodiments, the subsets, subpopulations or groupings may have previously been identified using methods that do not include clustering (e.g., method (c) above).

In QFM, multivariate adaptive binning is performed on a combined data set including the first data set (e.g., the first training population in the reduced dimension parameter dataspace) and the second data set (e.g., the second test population in the reduced parameter dataspace) to determine a multivariate combined binning pattern. Adaptive binning is a method for dividing k-dimensional data into k-dimensional bins such that all bins contain the same number of events, which correspond to items. This strategy requires k-dimensional bins of variable size that “adapt” to the structure of the data. Multivariate adaptive binning may be performed in two dimensions or in more than two dimensions (e.g., 3 dimensions, 4 dimensions, 5 dimensions, 6 dimensions, etc.). Multivariate adaptive binning begins by calculating the median and variance of the combined data for each of the k-dimensions included in the comparison. Next, the dimension j with the maximum variance is selected and the data is divided in half along the median value of that parameter, such that each bin contains an equal number of data points. This process proceeds recursively until a predefined threshold is met (e.g., minimum number of data points per bin). This results in a collection of k-dimensional hyper-rectangular bins, with each bin containing an equal number of data points. This recursive binning scheme is straightforward to implement and can be computed fast, with the dimension k of the measurement space affecting the computational complexity only linearly. Additional details regarding adaptive binning and multivariate adaptive binning can be found in Roederer et al., Probability binning comparison: a metric for quantitating multivariate distribution differences. Cytometry, (2001) 45: 47-55 and Roederer M. et al. Probability Binning Comparison: a metric for quantitating univariate distribution differences. Cytometry (2001); 45: 37-46, the contents of each of which is incorporated by reference herein in its entirety. The Roederer articles refer to adaptive binning as multivariate probability binning or probability binning (PB).

As noted above, in QFM, multivariate adaptive binning is performed on a combined data set including the first data set and the second data set to determine a multivariate combined binning pattern. The determined combined binning pattern is then applied separately to the first data set and the second data set. In some embodiments, application of the determined combined binning pattern to the first data set and the second data set includes, for at least some of the subsets/subpopulations/groupings in the first data set and the second data set, generating a histogram for the subset/subpopulation/grouping based on the determined combined binning pattern. In some embodiments, a histogram is generated for each identified subset/subpopulations in each of the samples. In some embodiments in which the subsets/subpopulations/groupings were determined via clustering, subsets/subpopulations/groupings may correspond to clusters.

For at least some combinations of a first identified subset/subpopulation/grouping in the first data set and a second identified subset/subpopulation/grouping in the second data set, a dissimilarity score is calculated for the combination based on a quadratic form distance for multi-dimensional data using the combined binning pattern applied to the first identified subset/subpopulation/grouping and the combined binning pattern applied to the second identified subset/subpopulation/grouping. In some embodiments, a dissimilarity score is calculated for each combination of an identified subset/subpopulation/grouping in the first sample data and an identified subset/subpopulation/grouping in the second sample data. In some embodiments, a dissimilarity score is calculated for each combination of first subset/subpopulation/grouping in the first data set for which a histogram was generated and a second subset/subpopulation/grouping in the second data set for which a histogram was generated. In some embodiments, histograms are generated for all subsets/subpopulations/groupings in the first data set and the second data set, and a dissimilarly score is calculated for each combination of a subset/subpopulation/grouping in the first data set and a subset/subpopulation/grouping in the second data set. In some embodiments, each dissimilarly score D²(h, f) is calculated using the following equation:

D²(h, f)=(h−f)^{T}A(h−f)=Σᵢ₌₁ⁿΣⱼ₌₁ⁿaᵢⱼ(hᵢ−fᵢ)(hⱼ−fⱼ) (1)

in which hᵢ is the relative frequency for bin i of the subset/subpopulation/grouping under consideration from the first data set as determined based on application of the combined binning pattern to the first data set. Similarly, fᵢ is the relative frequency for bin i of the subset/subpopulation/grouping from the second data set as determined based on application of the combined binning pattern to the second data set. Note that Σᵢhᵢ=Σᵢfᵢ=1 for relative frequencies. The matrix A=[aᵢⱼ] is a matrix of spatial dissimilarity between bins i and j. For D²(h, f) to be nonnegative, the matrix A needs to be nonnegative definite. To account for multidimensional spatial dissimilarity, the following equation can be used:

aᵢⱼ=1−d_{M}_{ᵢⱼ}/dₘₐₓ (2)

where d_{M}_{ᵢⱼ} is the Euclidean distance between centers of mass (as calculated on the combined data set) of the ith and jth bins, and dₘₐₓ is the maximum value of all the d_{M}_{ᵢⱼ}. D²(h, f) is always nonnegative for this choice of A. The dissimilarity score calculated using equations (1) and (2) is referred to as the QF dissimilarity score or QF score herein.

QF dissimilarity scores for the various combinations of a first subset/subpopulation/grouping in the first data set and a second subset/subpopulation/grouping in the second data set can be compared to identify corresponding or matched subsets/subpopulations/groupings in the first data set and the second data set in some embodiments. In some embodiments, a QF dissimilarity score may also be calculated between a first subset/subpopulation/grouping in the first training data sets and multiple subsets/subpopulations/groupings in the second data set (e.g., for example, a single subset/subpopulation/grouping in the first training data set could correspond to multiple subsets/subpopulations/groupings in the second data set, or vice versa). In some embodiments, a QF dissimilarity score may also be calculated between multiple subset/subpopulation/grouping in the first training data sets and multiple subsets/subpopulations/groupings in the second data set. For example, pairwise dissimilarity scores may be initially determined for each possible pair of subsets/subpopulations/groupings between the samples, and pairs with the smallest dissimilarity scores may be treated as matched. All other unmatched subsets/subpopulations/groupings may be treated as merging candidates. During the merging process, each merging candidate is combined with its nearest subset/subpopulation/grouping in the sample and the dissimilarity scores are then recalculated again. A decrease in the initial dissimilarity score as a result of the merging process indicates that a subset/subpopulation/grouping has spilt between the samples. The lower the QF dissimilarly score, the more closely matched the particular corresponding subsets/subpopulations/groupings are in the first data set and the second data set.

As noted above, in some embodiments QFM is applied to the subpopulations for the first training item population (e.g., first training cell population) and the subpopulations for the second test item population (e.g., second cell population) to determine subpopulations of the second test item population and/or to confirm the accuracy of the identified subpopulations of the second test item population, which generates dissimilarity scores including a dissimilarity score for each pair of matched subsets or subpopulations. After matched subsets or subpopulations are identified, a single dissimilarity score (e.g., a median dissimilarity score, an average dissimilarity score, etc.), which may be referred to herein as an overall match score, is determined from the dissimilarity scores for all identified matched subsets/subpopulations/groupings in the first training item population and the second item population. In some embodiments, the overall match score may be a median dissimilarity score for the set of dissimilarity scores for the corresponding matched subsets. In some embodiments, the overall match score may be an average dissimilarity score for the set of dissimilarity scores for the corresponding matched subsets.

In some embodiments, an overall dissimilarity score between corresponding matched subsets/subpopulations/groupings of the first training item population in the reduced parameter dataspace determined using supervised UMAP and of the second item population in the reduced parameter dataspace determined using supervised template-guided UMAP is used to determine, indicate, or confirm accuracy of the low-dimensional mapping of the second item population and/or of the identification of matching subsets/subpopulations/groupings (step 114). As indicated by the dashed line for the step 114 in FIG. 1, this step may not be performed in all embodiments.

In some embodiments, after performing supervised UMAP on a first training item (e.g., cell) population to produce a reduced dimensional embedding of the first training item population and performing template-guided UMAP on the second item (e.g., cell) population using the results of the supervised UMAP on the first training item population as a template, the method also includes:

1) Assigning each subset/subpopulation/grouping identified for the second item population to the label of the closest subset/subpopulation/grouping found in the supervised UMAP reduced parameter output for the first training item population where closeness is based on Euclidean distance in the reduced dimensional space as described in options (c) or (d) above, or using recognition method (a) or (b) described above;
2) Running QFM matching of reduced-parameter subsets/subpopulations/groupings for the first training item population and corresponding reduced-parameter subsets/subpopulations/groupings for the second item population formed by the label assignments in step 1) in the reduced dimensional space to compute dissimilarity scores for of matched subsets/subpopulations/groupings based on the assigned label;
3) Determining or confirming the overall accuracy of the match in the reduced dimensional space by comparing (A) the computed overall dissimilarity score for matched subsets/subpopulations/groupings of the first training population based on external classification with those of the second testing population in the reduced parameter dataspace as determined in step 2) with:

(B) a computed overall dissimilarity score for matched subsets/subpopulations/groupings of the first training/supervising data set based on external classification with subsets/subpopulations/groupings of the second test/supervised data set in the unreduced original dataspace; OR

(C) a computed overall dissimilarity score for matching subsets/subpopulations/groupings of the second test data set, which are defined by the same external classification method that was used to assign labels to the original first training data set, with matching subsets/subpopulations/groupings determined from the classification based on the supervised template-based UMAP reduced parameter representation of the same second test data set; OR

(D) a computed overall dissimilarity score for matching subsets/subpopulations/groupings of the second test data set, which are defined by the same external classification method that was used to assign labels to the first training data set, with subsets/subpopulations/groupings of the first training data, which are defined by the external classification method These may be referred to herein at QFM match scenarios A, B, C, and D.

For example, in some embodiments, an external classification method for fluorescence activated cytometry data may be manual gating, and a first supervising/training data set may have had manual gates applied by an expert to classify subsets of the first supervising/training data set. Supervised UMAP is performed on the first supervising/training data set that has manually assigned labels to produce a reduced parameter, also referred to herein as low-D, representation of the first supervising/training data set. Then the results of the supervised UMAP are used to perform supervised template-guided UMAP on the second supervised/test data set resulting in a low-D representation of the second supervised/test data set. Groupings, subsets or subpopulations in the low-D representation of the second supervised/test data set are recognized as corresponding to subsets in the first test data set using one of the four recognition methods described above to classify the groupings, subsets or subpopulations in the second supervised/test data. This may be described as supervised template-guided UMAP classification or UST classification of the second test data herein. QFM can be used to determine dissimilarity scores to determine the overall accuracy of the low-D or reduced-D representations and to determine the accuracy of classifications based on the supervised template-guided UMAP low-D representation of the second data. In some embodiments, the same external classification method was used to classify subsets of the second supervised/test data set. In some such embodiments, an overall QFM dissimilarity score can be calculated for two or more of:

1) low-D representations of subsets of the first training/supervising data set based on the external classification with matched subsets of the second test data set based on external classification (corresponding to QFM match scenario D);

2) low-D representations of subsets of the first supervising/training data set based on external classification of the first training data set with subsets from the supervised template-guided UMAP classification performed on the second test data (corresponding to QFM match scenario A); and

3) low-D representations of subsets from the supervised template-guided UMAP classification on the second test data set and subsets from the external classification performed on the second test data set (corresponding to QFM match scenario C).

In some embodiments, QFM produces a dissimilarity score for each match between at least one supervised template-guided UMAP identified subset and at least one classified subset.

In some embodiments, the following relation is used to determine whether the classification of the low-D subsets in the second sample via UST is accurate:

### IF

median DS(sample1_classified, sample2_UST) (corresponding to QFM match scenario A)
<=
median DS(sample1_classified, sample2_classified) (corresponding to QFM match scenario D)

### OR

median DS(sample2_classified, sample2_UST) (corresponding to QFM match scenario C)
<=
median DS(sample1_classified, sample2_classified) (corresponding to QFM match scenario D),
where sample1_classified is the low-D first training data based on external classification, sample2_classified is the low-D second test data based on external classification, and sample2_UST is the low-D second test data based on UST, which results from performing supervised template-based UMAP on the second test data and then using one of the four methods described above to recognize previously known or prior subsets/subpopulations/groupings in the low_D representation of the second test data corresponding to classified subsets or groupings in the first training data. In some embodiments, sample2_UST includes a listing of all low-D points and labels (subset group identifier) determined by one of the four recognition methods described above. In some embodiments, sample2_classified only comes with the subset group identifiers based on external classification but the position of each identifier is in the same position order as the low D points, which in turn is in the same position as the input rows of the raw data table upon which the works.

In some embodiments, the following relation is used to determine whether the classification of the low-D subsets in the second sample via UST is accurate:

### IF

median DS(sample1_classified, sample2_UST) (corresponding to QFM match scenario A)
<≈
median DS(sample1_classified, sample2_classified) (corresponding to QFM match scenario D)

### OR

median DS(sample2_classified, sample2_UST) (corresponding to QFM match scenario C)
<≈
median DS(sample1_classified, sample2_classified) (corresponding to QFM match scenario D).

Comparison of the QFM match scenario scores enable evaluation of the quality or trustworthiness of the subset classifications produced via UST.

In some embodiments, for the subsets identified from the supervised template-guided UMAP performed on the second test data and subsequent classifications (e.g., the UST classified subsets) to have merit, QFM match scenario A should produce an overall dissimilarity score similar to or lower than the dissimilarity score for QFM match scenario C or the dissimilarity score for QFM match scenario D.

In some embodiments, for the subsets identified from the supervised template-guided UMAP performed on the second test data and subsequent classifications (e.g., the UST classified subsets) to have merit, QFM match scenario C should produce an overall dissimilarity score similar to or lower than the dissimilarity score for QFM match scenario D.

In some embodiments, with respect to comparison of overall or median dissimilarity scores, one dissimilarity score being within 70% of another dissimilarity score is interpreted as the dissimilarity scores being similar to each other. In some embodiments, with respect to comparison of overall or median dissimilarity scores, one dissimilarity score being within 50% of another dissimilarity score is interpreted as the dissimilarity scores being similar to each other. In some embodiments, with respect to comparison of overall or median dissimilarity scores, one dissimilarity score being within 40% of another dissimilarity score is interpreted as the dissimilarity scores being similar to each other. In some embodiments, with respect to comparison of overall or median dissimilarity scores, one dissimilarity score being within 30% of another dissimilarity score is interpreted as the dissimilarity scores being similar to each other. In some embodiments, with respect to comparison of overall or median dissimilarity scores, one dissimilarity score being within 10% of another dissimilarity score is interpreted as the dissimilarity scores being similar to each other.

In some embodiments, the UST subsets, which are classified subsets, of the second item population may be visualized using a phenogram (e.g., a QF tree). In some embodiments, the relatedness of the UST subsets in the second item population and the classified subsets in the first training item population may be visualized using a phenogram for each.

In some embodiments, the method also includes generating a quadratic form tree (QF tree) or phenogram of the subpopulations in the second test item population (e.g., second test cell population) for visualization of relatedness between identified subpopulations. In some embodiments, the method also includes generating a QF tree or phenogram of the subpopulations in the second training item population (e.g., second training cell population) and a QF tree or phenogram of the subpopulations in the first training item for visualization of relatedness between identified subpopulations. These QF trees or phenograms are based on calculated dissimilarity scores.

The hierarchical tree-structure visualization in the QF-tree (phenogram) of the clusters or subsets enables agglomerative arrangement of identified clusters or subsets based on their dissimilarity in the space of measured parameters. This method builds the hierarchy from individual subsets/subpopulations/groupings by progressively merging subsets/subpopulations/groupings. In order to decide which subsets/subpopulations/groupings should be merged, a measure of dissimilarity between sets of observations is required. A combination of the multidimensional quadratic form score and Euclidean distance between clusters' medians was can be used as a dissimilarity measure to combine identified subsets/subpopulations/groupings in a bottom up manner: the branching diagram starts by placing subsets/subpopulations/groupings with the smallest pairwise dissimilarity scores in the lowest branches of the diagram; these pairs of subsets/subpopulations/groupings are progressively merged in the next branching level of the diagram and then considered as one subset/subpopulation/grouping; dissimilarity scores are then recalculated for all of the subsets/subpopulations/groupings on this branching level and the merging process is repeated. This process is sequentially repeated until all of the subsets/subpopulations/groupings identified within the sample are merged together. Specifically, the modification of the multidimensional quadratic form score that used as a measure of dissimilarity to progressively merge subsets/subpopulations/groupings is as follows: quadratic form+c*DM, where DM is the Euclidean distance between clusters' medians and c is a scaling factor ensuring that the smallest quadratic form score and the biggest DM are numbers of the same order of magnitude. Building such tree-structure display using the sum of quadratic form distance measure and the Euclidean distance as a measure of dissimilarity is computationally costlier than using just Euclidean distance, but distance metrics (such as quadratic form) that take into account changes in both location and frequency rather than just changes in one or the other are the most suitable and accurate methods for comparing some data distributions, such as multivariate non-parametric flow-cytometry data distributions. Here, Euclidean distance is added to quadratic form distance measure to ensure linear monotonic behavior for this dissimilarity measure. In some embodiments, a method includes detecting whether the second test/supervised data appears to have one or more new subpopulations, subsets, or groupings that do not correspond to any subpopulation or subset in the first training/supervised data prior to, during, or after performing supervised template-guided UMAP. In some embodiments, where the second test data appears to have one or more new subpopulations or subsets that do not correspond to any subpopulation or subset in the first training/supervising data, the method includes providing a warning or a notification of the new subpopulation, subset, or grouping in the second test data. In some embodiments, where the second test data appears to have one or more new subpopulations, subsets, or groupings that do not correspond to any subpopulation or subset in the first training/supervising data, the method includes pausing, suspending, terminating, or not initiating performing supervised template-guide UMAP on the second test data thereby avoiding “false positives” that can result when performing supervised-template guided UMAP on test data that contains subsets, subpopulations, or groupings that do not correspond to any subsets or subpopulations in the training data. In some embodiments, where the second test data appears to have one or more new subpopulations, subsets, or groupings that do not correspond to any subpopulation or subset in the first training/supervising data, the method may include suspending, pausing, or not initiating the performing supervised template-guide UMAP, and prompting a user to enter input indicating whether to proceed with performing supervised template-guide UMAP on the second test data.

For example, if the subpopulations in the first training data set are labeled C¹, . . . , Cⁿ, each subpopulation C^{j} has a mean m^{j}ᵢ and a standard deviation s^{j}ᵢ in each dimension i. For each data point x in the second test data set, each subpopulation C^{j}, and each dimension i the following value is determined

$$\frac{\vert {x}_{i} - {m}_{i}^{j} \vert}{{s}_{i}^{j}}$$

and compared with a threshold constant (e.g., 3.66). If the value is larger than the threshold constant for at least three dimensions, the datapoint x in the second test data set is not considered to belong to the subpopulation Cj. If it is determined that the data point x in the second test data set does not below to any subpopulation, x is considered to below to a new subpopulation that does not correspond to any subpopulations in the first training data set. If more than a threshold percentage of fraction of the data points in the second test data set belong to a new subpopulation (e.g., more than 13% of the data points), the second test data set may be deemed to appear to have one or more new subpopulations or subsets that do not correspond to any subpopulation or subset in the first training/supervising data.

For some phenotyping flow cytometry experiments 3.66, would be an acceptable value for the threshold constant. As would be appreciated by one of ordinary skill in the art in view of the present disclosure, the threshold could be modified or fine-tuned for each type of data or assay on that a supervised template would be expected to see. For example, data obtained from an assay looking for an allergy response on basophils may differ in the constant for dimensions measured by CD203 or CD63 marker in some embodiments, whereas one looking for a another type of stimulation response (or stimulation response) with B cells might differ with the IgM biomarker. For non-flow cytometry embodiments, routine experimentation is specific domains could be employed to determine the threshold constant for each specific dimension of the data.

In some embodiments, where the method detects that the second test data set appears to have one or more new subpopulations, subsets, or groupings that do not correspond to any subpopulation or subset in the first training/supervising data when preforming supervised template-guided UMAP, the method includes providing the option to perform a re-supervised reduction on the second test data that appears to correspond to one or more new subpopulations. For example, in some embodiments, instead of initiating or completing supervised template-guided UMAP on the second test data, supervised UMAP is performed on the second test data instead. This requires generating supervising labels for the second data set, which, in some embodiments, includes assigning all data points in the second data set that are considered to belong to a new subpopulation, new subset or new grouping (e.g., data points in the second data set that were determined not to correspond to any subpopulation or subset in the first data set based on the analysis above) to a new supervisor label. All other data points that are not considered to belong to a new subpopulation are given the supervisor label that corresponds to the subpopulation Cj that minimizes the following sum:

$${\sum }_{i} \frac{\vert {x}_{i} - {m}_{i}^{j} \vert}{{s}_{i}^{j}}$$

Supervised UMAP is then performed on the second data set using these supervisor labels.

In some embodiments, the method provides a new push/pull gradient descent that treats test set data which appears untrained differently, which may be referred to herein as a “joined transform” method. The joined transform is sensitive to data sets that contain subsets, subpopulations, or groupings that are incompatible and too different from the subsets or subpopulations represented by the classification labels of a supervised template. When doing a supervised template reduction, the method for a supervised template reduction may be modified to a joined transform if it is known the test set is likely to have distinctly new types of subsets or subpopulations not seen by the training set. This avoids false positives and false negatives. In some embodiments, where the method detects that the second test data set appears to have one or more new subpopulations, subsets, or groupings that do not correspond to any subpopulation or subset in the first training/supervising data when preforming supervised template-guided UMAP, the method includes providing the option to perform the joined transform method on the second test data set.

The joined transform method is similar to template-guided UMAP except with two key differences. First, the nearest neighbors of each data point in the second data set are taken from the union of the first training data set and the second data set. In other words, both the first training data set and the second data set are used to determine the nearest neighbors of each point in the second data set. Second, during stochastic gradient descent, the attractive and repulsive forces are applied as before, but the first training set data points do not move as their position is considered already correctly determined, while the second test data points move as usual. The ideas is that if the second test data set contains a genuinely new subpopulation, then searching for nearest neighbors among the first training dataset is insufficient, and nearest neighbors can only be found among the test dataset.

In some embodiments, where the method detects that the second test data set appears to have one or more new subpopulations or subsets that do not correspond to any subpopulation or subset in the first training/supervising data when preforming supervised template-guided UMAP, the method includes: providing the option to perform a re-supervised reduction on the second test data; providing the option to perform a joined transform on the second test data; or both.

As noted above, for cytometry, in some embodiments, methods enable the application of gating from one sample to determine subsets or subpopulations of cells to compatible samples without re-running gating for each compatible sample in some embodiments, thereby increasing efficiency for identification of subpopulations of cells (e.g., different types of cells) in cytometry data from biological samples. Gating for the training sample can be by any suitable method, which can be manual, semi-automated or fully automated. Examples include, but are not limited to, gating using the Exhaustive Projection Pursuit (EPP) functionality in AutoGate software by Cytogenie.org available at www.cytogenie.org, using flowMeans: Non-parametric Flow Cytometry Data Gating software by Nima Aghaeepour available at bioconductor.org/packages/release/bioc/html/flowMeans.html, using the FlowSOM algorithm by Van Gassen implemented in Cytobank software from Cytobank, Inc., using the X-shift algorithm by Samusik et al. available as VorteX software code at github.com/nolanlab/vortex, or using SWIFT:Scalable Weighted Iterative Flow-Clustering Technique software available online from the Mosmann Lab at the University of Rochester Medical Center.

In some embodiments, methods enable efficient identification (e.g., classification) of different functional subpopulations of cells in cytometry data. In some embodiments, methods enable efficient identification of different functional subpopulations of cells in cytometry data and verification of accuracy of identification of different functional subpopulations of cells in cytometry data. In some embodiments, methods enable efficient identification of different functional subpopulations of cells in test cytometry data for multiple test samples while detecting and providing notifications regarding any test samples with new subpopulations not present in training data. In some embodiments, methods enable efficient identification of different functional subpopulations of cells in test cytometry data for multiple test samples while avoiding problems with false positives associated with test samples having new functional subpopulations of cells not present in training data.

Computing Systems and Devices for Implementing Embodiments

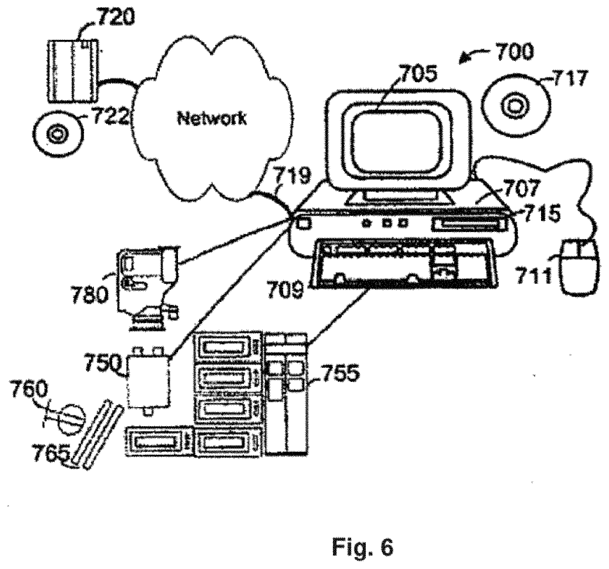

FIG. 6 is a block diagram showing a representative example computing system or computing device in which various aspects of the present invention may be embodied. As will be understood from the teachings provided herein, the invention can be implemented in hardware and/or software. In some embodiments, different aspects of the invention can be implemented in either client-side logic or server-side logic. Moreover, the invention or components thereof may be embodied in a fixed media program component containing logic instructions and/or data that when loaded into an appropriately configured computing device cause that device to perform according to the invention. A fixed media containing logic instructions may be delivered to a viewer on a fixed media for physically loading into a viewer's computer or a fixed media containing logic instructions may reside on a remote server that a viewer accesses through a communication medium in order to download a program component.

FIG. 6 shows an information appliance, computing system, or digital device 700 that may be understood as a logical apparatus, computing system, or computing device that can perform logical operations regarding image display and/or analysis as described herein. Such a device can be embodied as a general purpose computer system or workstation running logical instructions to perform according to some embodiments of the present invention. Such a device can also be custom and/or specialized laboratory or scientific hardware that integrates logic processing into a machine for performing various sample handling operations. In general, the logic processing components of a device according to some embodiments of the present invention is able to read instructions from media 717 and/or network port 719, which can optionally be connected to server 720 having fixed media 722. Apparatus 700 can thereafter use those instructions to direct actions or perform analysis as understood in the art and described herein. One type of logical apparatus that may embody the invention is a computer system as illustrated in 700, containing CPU 707, optional input devices 709 and 711, storage media (such as disk drives) 715 and optional monitor 705. Fixed media 717, or fixed media 722 over port 719, may be used to program such a system and may represent a disk-type optical or magnetic media, magnetic tape, solid state dynamic or static memory, etc. The invention may also be embodied in whole or in part as software recorded on this fixed media. Communication port 719 may also be used to initially receive instructions that are used to program such a system and may represent any type of communication connection.

FIG. 6 also shows additional components that can be part of a diagnostic system in some embodiments. These components include a microscope or viewer or detector 750, sampling handling 755, light source 760 and filters 765, and a CCD camera or capture device 780 for capturing digital images for analysis as described herein for luminance detection of biomarkers. It will be understood to those of skill in the art that these additional components can be components of a single system that includes logic analysis and/or control. These devices also may be essentially stand-alone devices that are in digital communication with an information appliance such as 700 via a network, bus, wireless communication, etc., as will be understood in the art. It will be understood that components of such a system can have any convenient physical configuration and/or appear and can all be combined into a single integrated system. Thus, the individual components shown in FIG. 6 represent just one example system.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

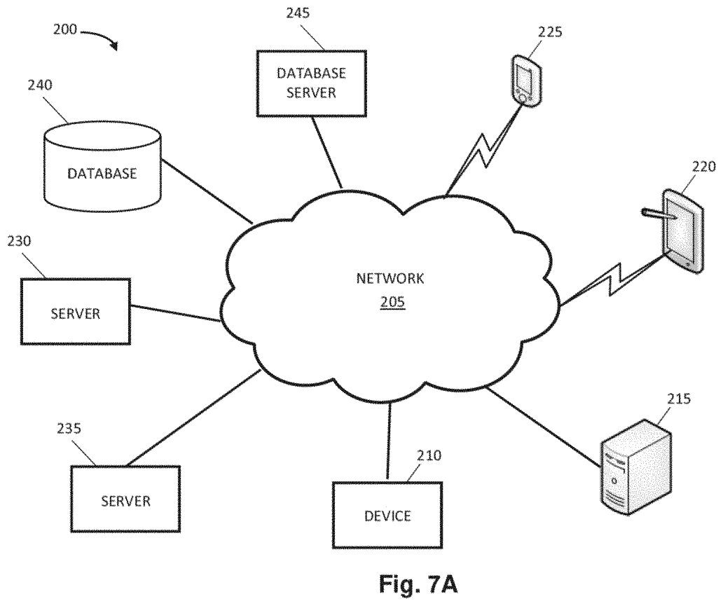

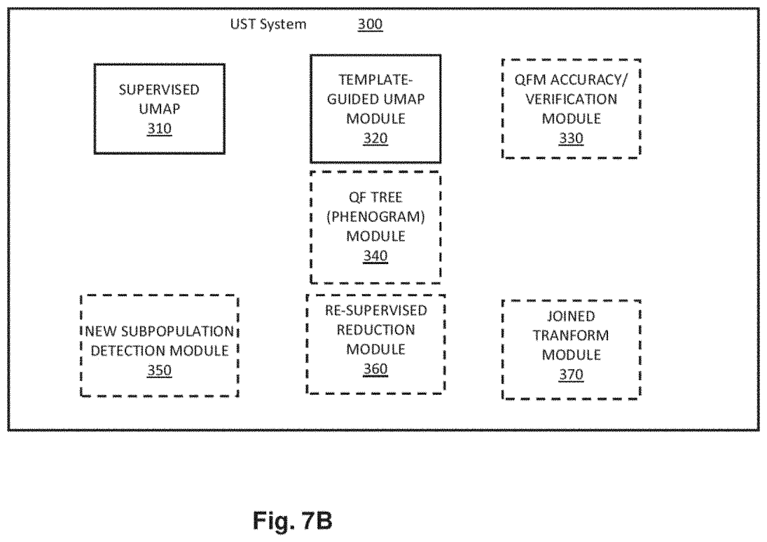

FIG. 7A illustrates a network diagram depicting an example system 200 that can be used in part or in full in to implement methods described herein in accordance with an embodiment. The system 200 can include a network 205, a device 210, a device 215, a device 220, a device 225, a server 230, a server 235, a database(s) 240, and a database server(s) 245. Each of the devices 210, 215, 220, 225, servers 230, 235, database(s) 240, and database server(s) 245 is in communication with the network 205.

In an embodiment, one or more portions of network 205 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The devices 210, 215, 220, 225 may include, but are not limited to, work stations, personal computers, general purpose computers, Internet appliances, laptops, desktops, multi-processor systems, set-top boxes, network PCs, wireless devices, portable devices, wearable computers, cellular or mobile phones, portable digital assistants (PDAs), smartphones, tablets, ultrabooks, netbooks, multi-processor systems, microprocessor-based or programmable consumer electronics, mini-computers, and the like. Each of the devices 210, 215, 220, 225 may connect to network 205 via a wired or wireless connection.

In some embodiments, server 230 and server 235 may be part of a distributed computing environment, where some of the tasks/functionalities are distributed between servers 230 and 235. In some embodiments, server 230 and server 235 are part of a parallel computing environment, where server 230 and server 235 perform tasks/functionalities in parallel to provide the computational and processing resources necessary to generate the Bayesian causal relationship networks described herein.

In some embodiments, each of the server 230, 235, database(s) 240, and database server(s) 245 is connected to the network 205 via a wired connection. Alternatively, one or more of the server 230, 235, database(s) 240, or database server(s) 245 may be connected to the network 205 via a wireless connection. Although not shown, database server(s) 245 can be directly connected to database(s) 240, or servers 230, 235 can be directly connected to the database server(s) 245 and/or database(s) 240. Server 230, 235 includes one or more computers or processors configured to communicate with devices 210, 215, 220, 225 via network 205. Server 230, 235 hosts one or more applications or websites accessed by devices 210, 215, 220, and 225 and/or facilitates access to the content of database(s) 240. Database server(s) 245 includes one or more computers or processors configured to facilitate access to the content of database(s) 240. Database(s) 240 include one or more storage devices for storing data and/or instructions for use by server 230, 235, database server(s) 245, and/or devices 210, 215, 220, 225. Database(s) 240, servers 230, 235, and/or database server(s) 245 may be located at one or more geographically distributed locations from each other or from devices 210, 215, 220, 225. Alternatively, database(s) 240 may be included within server 230 or 235, or database server(s) 245.

FIG. 7B is a block diagram showing a UMAP Supervised Templates (UST) system 300 implemented in modules according to an example embodiment. In some embodiments, the modules include a supervised UMAP module 310, and a template-guided UMAP module 320. In some embodiments, the modules also include a QFM accuracy/verification module 330. In some embodiments, the modules also include QF tree (phenogram) module 340. In some embodiments, the modules also include a new population detection module 350. In some embodiments, the modules also include a re-supervised reduction module 360. In some embodiments, the modules also include a joined transform module 370. In some embodiments, modules 310, 320, 330, 340, 350, 360, and 370 are included in the same system. In an example embodiment, one or more of modules 310, 320, 330, 340, 350, 360, and 370 are included in server 230 and/or server 235 while other of the modules 3310, 320, 330, 340, 350, 360, and 370 are provided in the devices 210, 215, 220, 225.

In alternative embodiments, the modules may be implemented in any of devices 210, 215, 220, 225. The modules may include one or more software components, programs, applications, apps or other units of code base or instructions configured to be executed by one or more processors included in devices 210, 215, 220, 225.

Although modules 310, 320, 330, 340, 350, 360, and 370 are shown as distinct modules in FIG. 7B, it should be understood that modules 310, 320, 330, 340, 350, 360, and 370 may be implemented as fewer or more modules than illustrated. It should be understood that any of modules 3310, 320, 330, 340, 350, 360, and 370 may communicate with one or more external components such as databases, servers, database server, or other devices.

In some embodiments, the supervised UMAP module 310 is a software-implemented module, or a module implemented at least partially in hardware and at least partially in software, configured to perform supervised UMAP on high-dimensional data having labels to produce a reduced dimension output (e.g., 2D or 3D output).

In some embodiments, the template-guided UMAP module 320 is software-implemented module, or a module implemented at least partially in hardware and at least partially in software, configured to perform template-guided UMAP on a new data set based on output from the supervised UMAP module 310.

In some embodiments, the QFM accuracy/verification module 330 is a software-implemented module, or a module implemented at least partially in hardware and at least partially in software, configured to determine a dissimilarity score between labeled and identified subsets of training data and labeled and identified subsets of sample or test data.

In some embodiments, the QF tree (phenogram) module 340 is a software-implemented module, or a module implemented at least partially in hardware and at least partially in software, configured to generate a QF tree (phenogram) and a corresponding visual representation for the training data and for the test or sample data based on the subsets identified in the training data and the test or sample data.

In some embodiments, the new subpopulation detection module 350 is software-implemented module, or a module implemented at least partially in hardware and at least partially in software, configured to determine whether a second test population appears to have one or more subpopulations that do not correspond to any subpopulations in a first training population.

In some embodiments, the re-supervised reduction module 360 is software-implemented module, or a module implemented at least partially in hardware and at least partially in software, configured to perform a re-supervised reduction as described above on second test data having one or more new subpopulations that do not correspond to any subpopulations in first training data.

In some embodiments, the joined transform module 370 is software-implemented module, or a module implemented at least partially in hardware and at least partially in software, configured to perform parameter reduction using the “joined transform” method described above.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA), an application-specific integrated circuit (ASIC), or a Graphics Processing Unit (GPU)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

For the purposes of this disclosure, a non-transitory computer readable medium stores computer programs and/or data in machine readable form. By way of example, and not limitation, a computer readable medium can include computer storage media and communication media. Computer storage media includes volatile and non-volatile, removable and non-removable media implemented in any method or technology for storage of information such as computer-readable instructions, data structures, program modules, and specific applications.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 8 is a block diagram of a machine in the example form of a computer system 900 within which instructions for causing the machine (e.g., device 210, 215, 220, 225; servers 230, 235; database server(s) 240; database(s) 230) to perform any one or more of the methodologies discussed herein may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a multi-core processor, and/or a graphics processing unit (GPU)), a main memory 904 and a static memory 906, which communicate with each other via a bus 908. The computer system 900 may further include a video display unit 910 (e.g., a liquid crystal display (LCD), a touch screen, or a cathode ray tube (CRT)). The computer system 900 also includes an alphanumeric input device 912 (e.g., a physical or virtual keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Other embodiments will be apparent to those of skill in the art. In particular, a viewer digital information appliance has generally been illustrated as a personal computer. However, the digital computing device is meant to be any information appliance suitable for performing the logic methods of the invention, and could include such devices as a digitally enabled laboratory systems or equipment, digitally enabled television, cell phone, personal digital assistant, etc. Modification within the spirit of the invention will be apparent to those skilled in the art. In addition, various different actions can be used to effect interactions with a system according to some embodiments of the present invention. For example, a voice command may be spoken by an operator, a key may be depressed by an operator, a button on a client-side scientific device may be depressed by an operator, or selection using any pointing device may be effected by the user.

Logic systems and methods such as described herein can include a variety of different components and different functions in a modular fashion. Different embodiments of the invention can include different mixtures of elements and functions and may group various functions as parts of various elements. For purposes of clarity, the invention is described in terms of systems and/or methods that include many different innovative components and innovative combinations of innovative components and known components. According to aspects of the disclosed subject matter described herein the subject matter is in part described with reference to block diagrams and operational illustrations of methods and devices and devices implementing methods to qualitatively and quantitatively analyze distributions of data. It is understood that each block of the block diagrams or operational illustrations, and combinations of blocks in the block diagrams or operational illustrations, can be implemented by means of analog or digital hardware and computer program instructions or combinations thereof.

These computer program instructions can be provided to a processor of a general purpose computer, special purpose computer, microcontroller, ASIC, or any other programmable data processing apparatus (a “computing device”), such that the instructions, which execute via the processor of the computing device or other programmable data processing apparatus, implement the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. In addition different blocks may be implemented by different processors, such as an array or processors operating in series or parallel arrangement, and exchanging data and/or sharing common data storage media.

### EXAMPLES

In the examples, the inventors took published data from various sources and reanalyzed it using the methods disclosed herein involving performing supervised UMAP on a training data set, and using the parameter reduced result as template data to perform template guided UMAP on second data without labels, thereby performing supervised template guided UMAP on the second data. After performing supervised template guided UMAP on the second data, subsets, subpopulations or groupings in the reduced parameter (i.e., low-D) representation of the second data were identified and recognized as corresponding to or matched to subgroups and subpopulations of the first training data using recognition methods (b), (c) or (d) described above. For recognition methods (b) and (d) density based merging was employed for clustering. For some data sets, recognition was based on identifying the closest training set data point to a test set data points. For some data sets, a combination of recognition methods was employed.

After performing supervised template-based UMAP on the second test data and identifying and recognizing subsets, subpopulations, or groupings in the low-D representation of the second test data that matched prior subsets or subpopulations in the first training data to classify subsets or subpopulations in the second test data, QF trees, also referred to herein as phenograms, were used to visualize and compare classified subsets in the first training data and identified subsets in the other test data. The results demonstrated the ability of methods described herein to accurately and efficiently identify subsets in unclassified data.

### Example 1: Widely Varying Subset Frequencies (11 Parameters Classifying 13 Subsets)

UMAP, supervised UMAP, and supervised template-guided UMAP was performed on data from high-dimensional flow cytometry (i.e., FACS) with stains for distinguishing markers in single live PerC cells from BALB/C adult mice. Data was collected without LPS stimulation and separate data was collected after LPS stimulation. The following subsets were identified based on gating: B cells, macrophages (MO), dendritic cells (DCs), eosinophils, mast cells, neutrophils, T cells, natural killer cells, and invariant natural killer T cells. Approximately 40% of the PerC cells are B-lymphocytes. Among the remaining “non-B” PerC cells, the majority coexpress CD11b and F4/80 and hence are appropriately characterized as MØ. Among these, two unique MØ subsets, which were referred to as SPMs and LPMs, were found. LPM was the most abundant MØ subset (approximately 90% of PerC MO) in unstimulated mice; SPM accounted for the remaining 10% of the PerC MO. Further information regarding the cells and the gating may be found in Ghosn, E. et al., Two physically, functionally, and developmentally distinct peritoneal macrophage subsets, Proceedings of the National Academy of Sciences Feb 2010, 107 (6) 2568-2573; DOI: 10.1073/pnas.0915000107, which is incorporated by reference herein in its entirety.

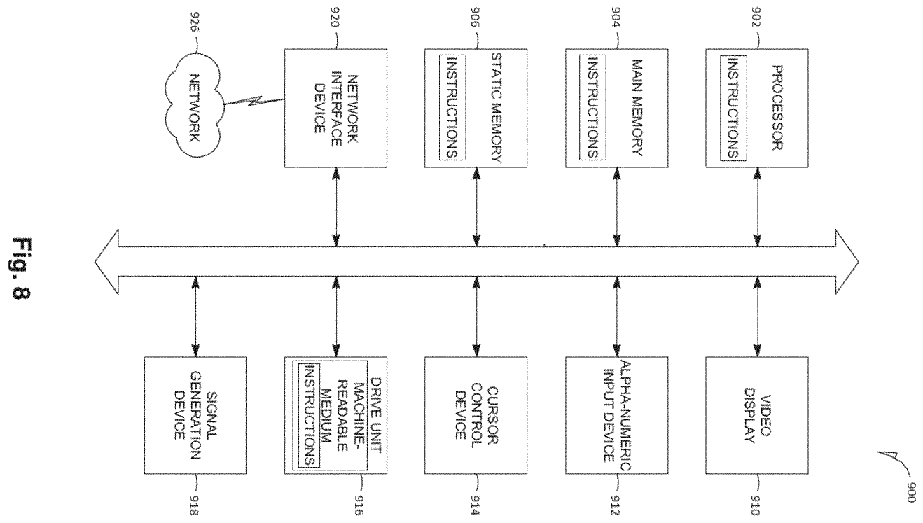

This data showed widely varying subset frequencies with 11 fluorescent/scatter parameters classifying 13 subsets. FIG. 9 includes graphs from Ghosn et al. showing the gating to identify cell populations.

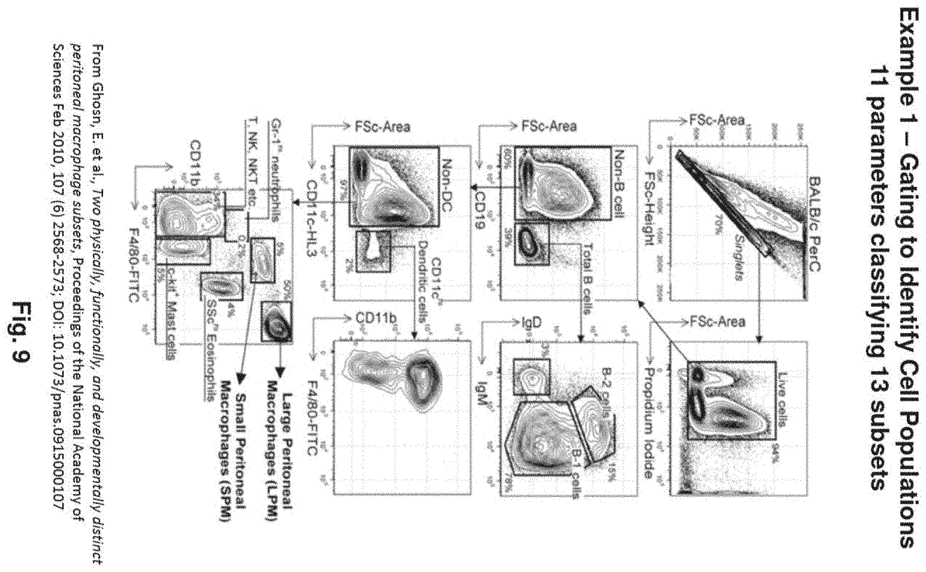

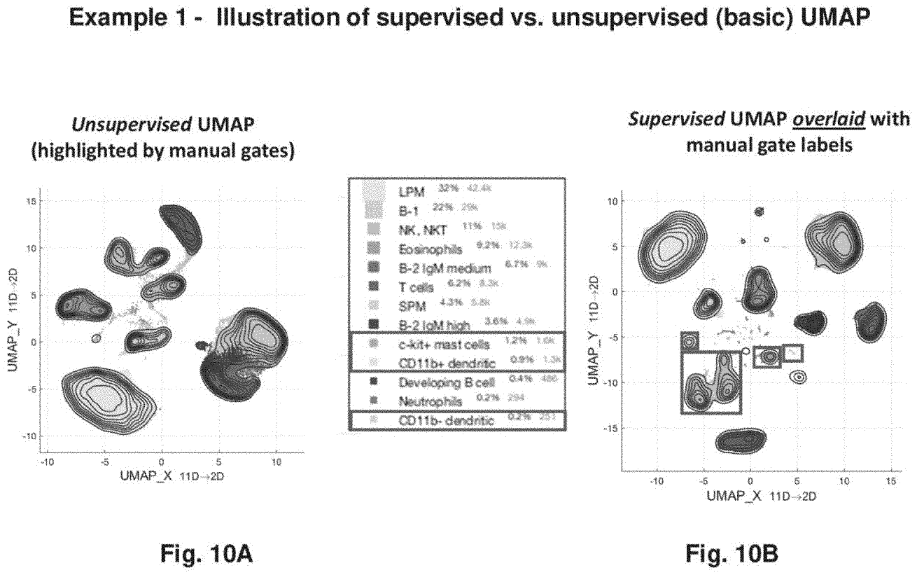

FIGS. 10A and 10B illustrate the benefit of using supervised UMAP instead of unsupervised (basic) UMAP. FIG. 10A shows the results from performing unsupervised (basic) UMAP on data from a Balb/c mouse sample where the manual gating is highlighted by color identifying different cell groups. FIG. 10B shows the result of supervised UMAP on the data from the Balb/c mouse sample overlaid with the manual gate labels. Supervised UMAP produces a superior result as compared to unsupervised UMAP. Supervised UMAP finds c-kit+ mast cell, CD11b+ dendritic cell, and CD11b− dendritic cell clusters. Supervised UMAP maintains the subdivision between NK and NKT cells even though both cells groups had the same supervising label.

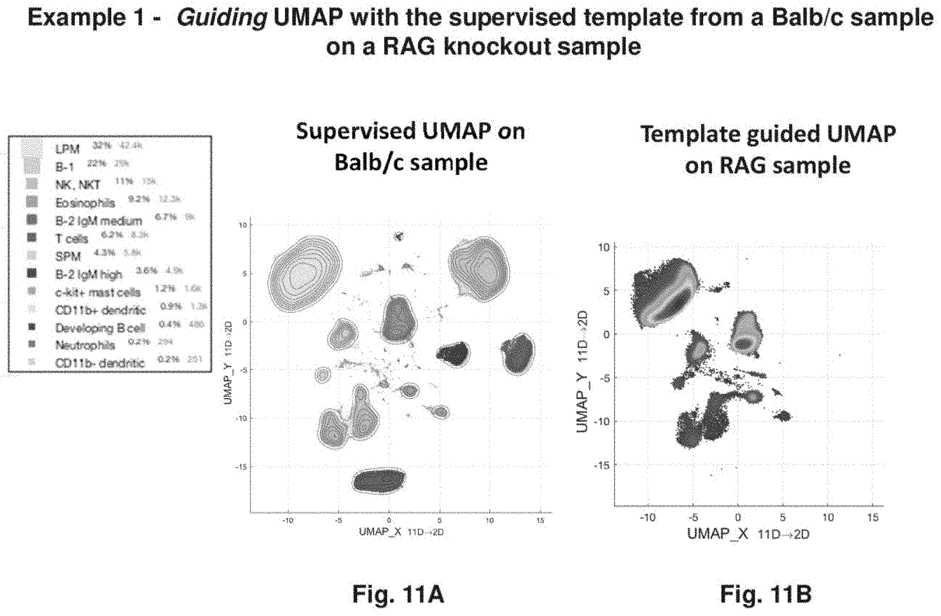

FIG. 11A is a graph of the resulting low dimensional data from performing supervised UMAP on data from the Balb/c mouse sample. The result of this dimensional reduction performed on the labeled Balb/c sample was used in template-guided UMAP to perform supervised template-guided UMAP on data obtained from RAG knockout (RAG−/−) mouse cells. FIG. 11B is a graph of the result of the supervised template-guided UMAP performed on the RAG sample.

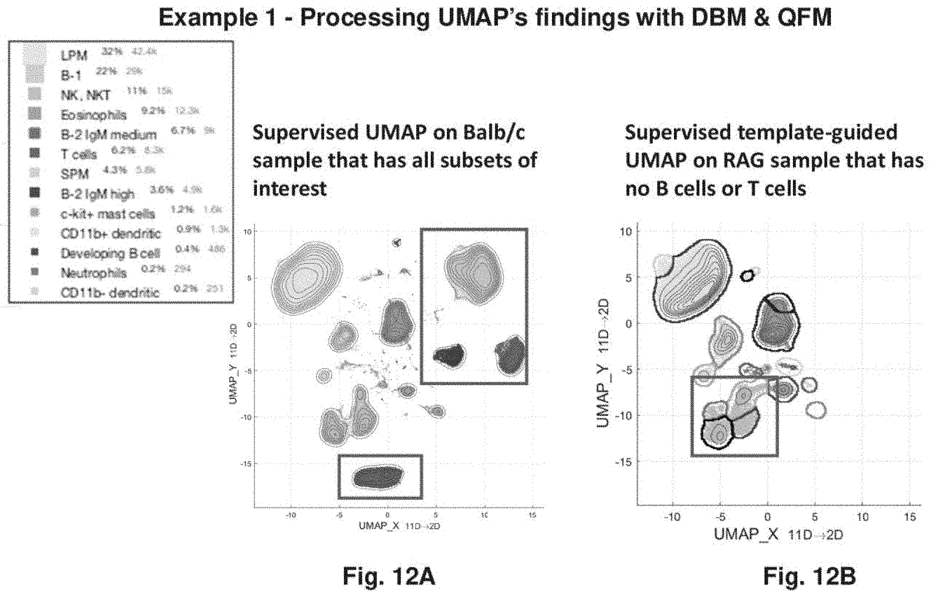

The output of the supervised UMAP for the Balb/c sample data and the output of the supervised template-guided UMAP on the RAG sample data were further processed using density based merging (DBM) and QFM to recognize subsets or subpopulations in the reduced parameter data for the RAG sample that has no B cells or T cells corresponding to externally classified populations in the training Balb/c sample. In FIG. 12A, the supervised UMAP for the Balb/c samples has all eleven subsets of interest. In FIG. 12B, the supervised template-guided UMAP for RAG samples confirmed that the RAG samples have no B cells or T cells. The supervised template-guided UMAP found a four-way subdivision of the NK and NKT cells even though they were guided by the same original supervising label.

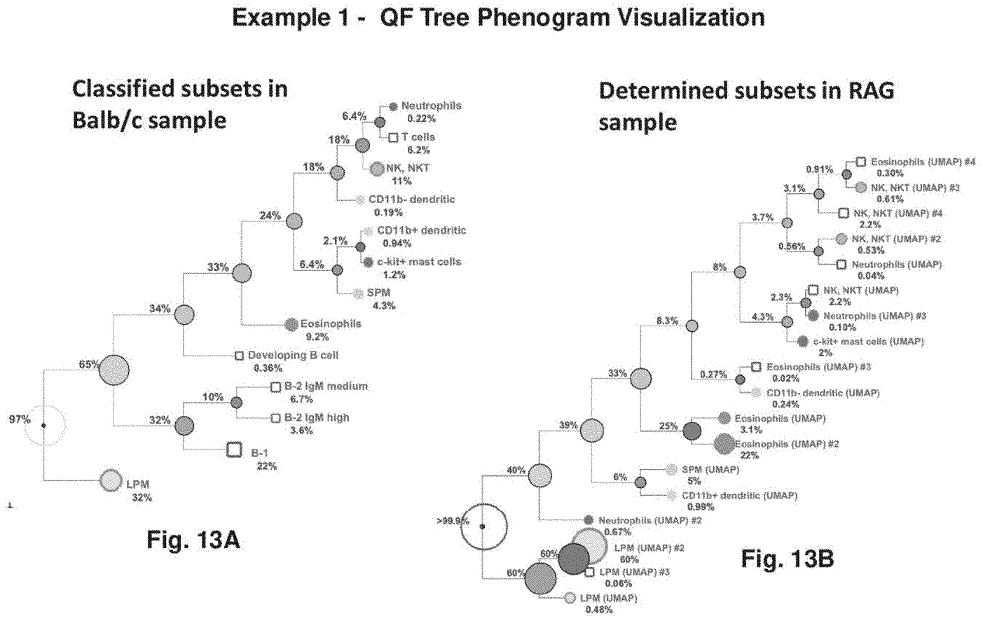

FIGS. 13A and 13B show QF tree, also known as phenogram, visualizations of the classified subsets in the training Balb/c sample and of the determined subsets in the RAG sample.

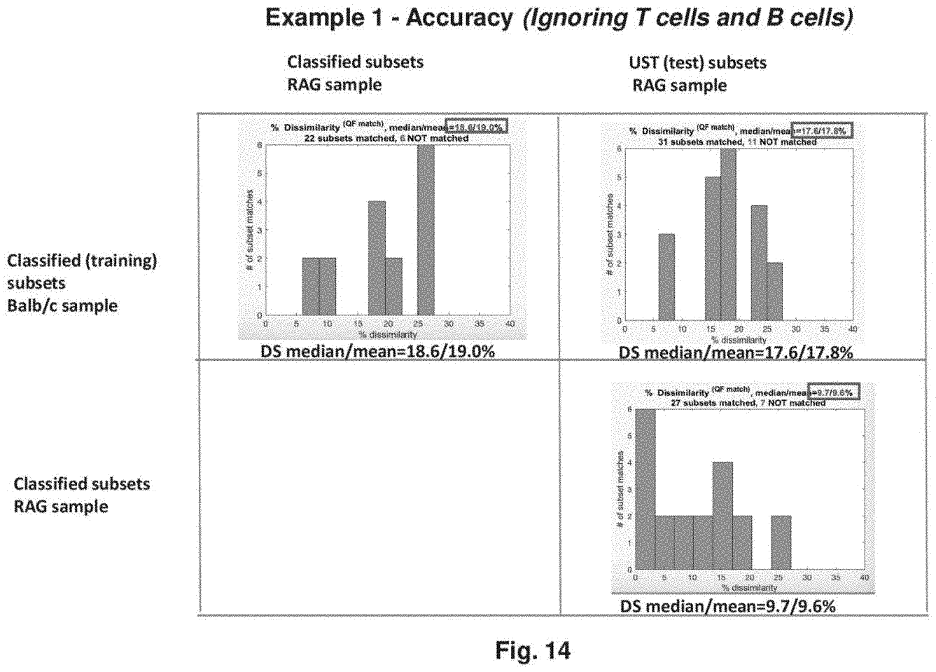

FIG. 14 includes graphs of overall dissimilarity scores determined from different QFM match scenarios for determining or verifying accuracy of the parameter reduction and subset identification for the supervised template-guided UMAP (UST) performed on the RAG sample. Dissimilarity scores were not calculated for the T cells and B cells which were not present in the RAG sample. The term UST subsets refers to subsets that were identified and classified from low-D test data produced by supervised template-guided UMAP on which one of the recognition methods described above was performed. As shown in FIG. 14, on the upper right, the median/mean dissimilarity scores between the matched manually classified training Balb/c subsets and the RAG test subsets determined by UST were 17.6%/17.8% (corresponding to QFM match scenario A), which were less than the 18.6%/19.0% median/mean dissimilarity scores on the upper left between the matched manually classified Balb/c subsets and the manually classified RAG subsets (corresponding to QFM match scenario D), indicating that the identification of subsets in the test RAG data based on supervised template-guided UMAP performed as well or better than manual classification of subsets in the test RAG data. The lower right corner shows median/mean dissimilarity scores between the matched manually classified training RAG subsets and the RAG test subsets determined by UST were 9.7%/9.6% (corresponding to QFM match scenario C). Testing confirmed that UST identification of subsets performed similar to the best methods found in the FlowCAP effort that the flow cytometry community has been engaging in over the last 10 years.

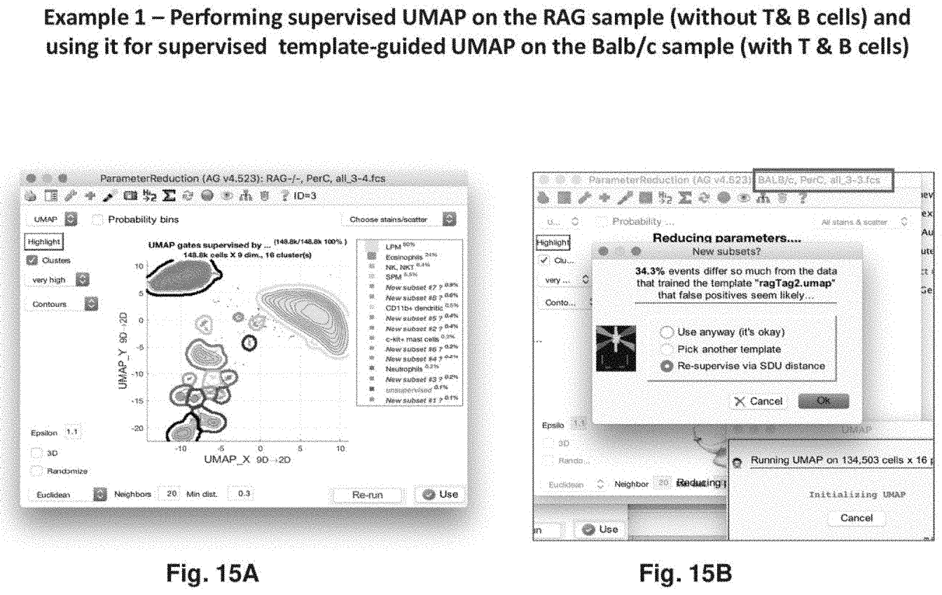

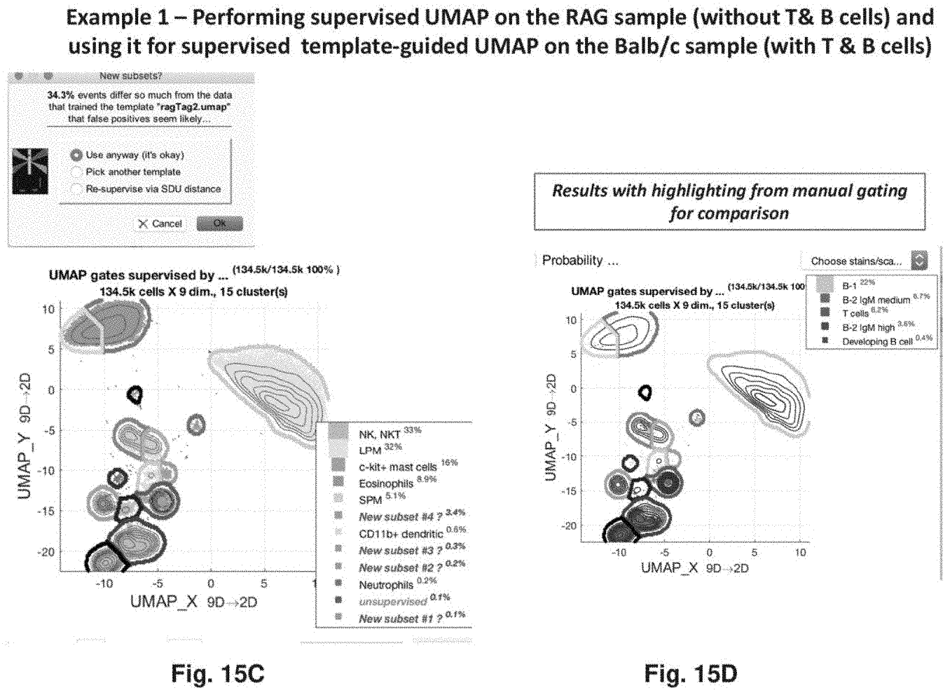

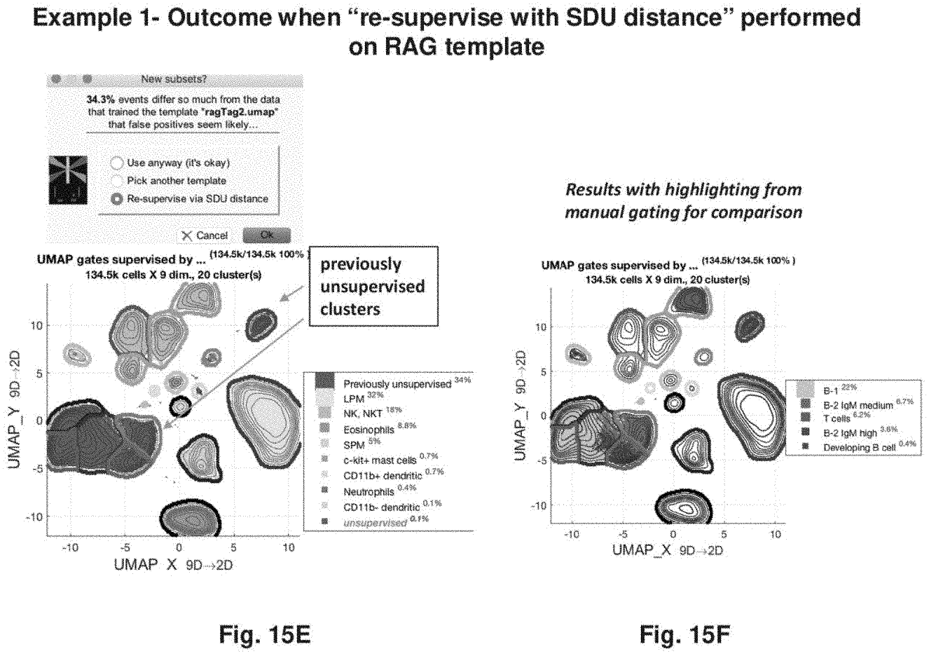

The same two data sets were again used for comparison, but this time the RAG sample data was used as training data by performing supervised UMAP on the RAG sample data and then applying the result as a template for supervised template-guided UMAP on the Balb/c sample data. FIG. 15A shows the result of supervised UMAP performed on the RAG sample. FIG. 15B shows a warning window notifying a user that the Balb/c sample likely includes subsets not present in the training data. When the warning was ignored and the user proceeded with performing supervised template-guided UMAP using the RAG template on the Balb/c sample data, the result is shown in FIG. 15C. FIG. 15D shows results annotated with manually gated subsets to illustrate the problem with the results. The results included false positives and indications that B and T cells were misidentified as NK, NKT or ckit+mast cells. This Example illustrates the importance of incorporating a feature or a step in the method to determine whether the data on which the supervised template-guided UMAP is to be performed likely has subsets that do not correspond to any subsets of training data used to make the supervised template.

FIG. 15E depicts the situation of the resulting graph where the warning was not ignored and the RAG template data was re-supervised with standard-deviation-unit (SDU) Hi-D distance to create new labels, then used with the new labels for supervised UMAP on the Balb/c data. FIG. 15F is the same graph highlighted with known subsets for clarification. FIGS. 15E and 15F show that the supervision with SDU distance produced supervised UMAP output for the Balb/c sample that correctly separated the B and T cells.

### Example 2: Very Similar Subset Frequencies (18 Parameters Classifying 10 Subsets)

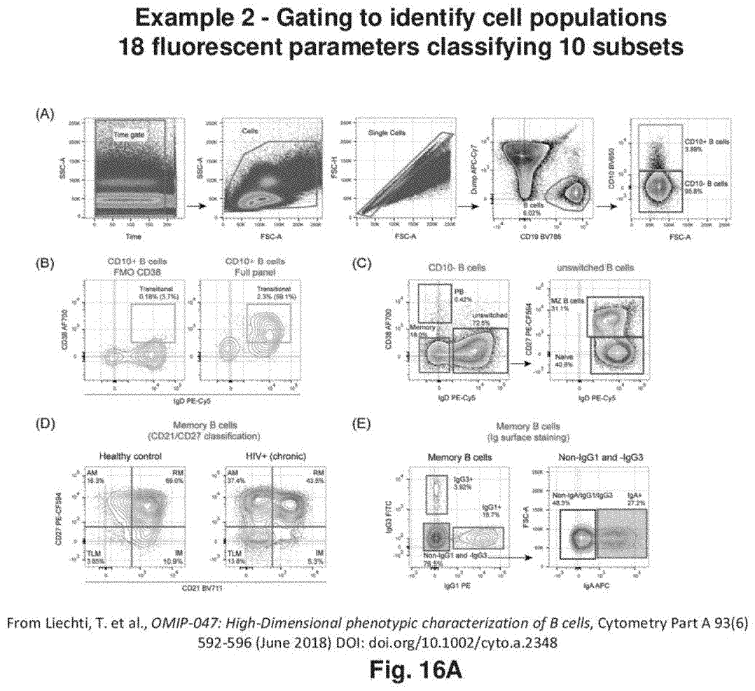

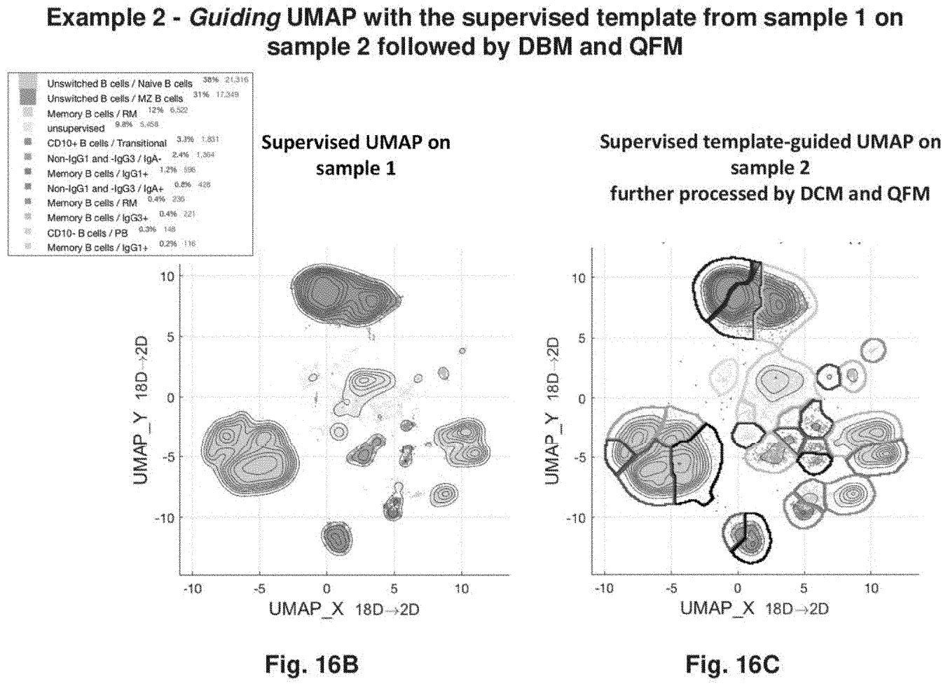

Supervised template-guided UMAP was performed on data from high-dimensional flow cytometry of peripheral blood mononuclear cells (PMBC) in healthy donors and in the context of chronic viral diseases such as HIV-1 infection. The panel used was a 16-color, 18-parameter panel design to allow detailed dissection of human B cell subsets and their phenotype. Graphs showing the gating for identification of cells types appear in FIG. 16A. Further information regarding the cells and the gating may be found in Liechti, T. et al., OMIP-047: High-Dimensional phenotypic characterization of B cells, Cytometry Part A 93(6) 592-596 (June 2018) DOI: doi.org/10.1002/cyto.a.2348.

This data showed very similar subset frequencies with 18 fluorescent parameters classifying 10 subsets.

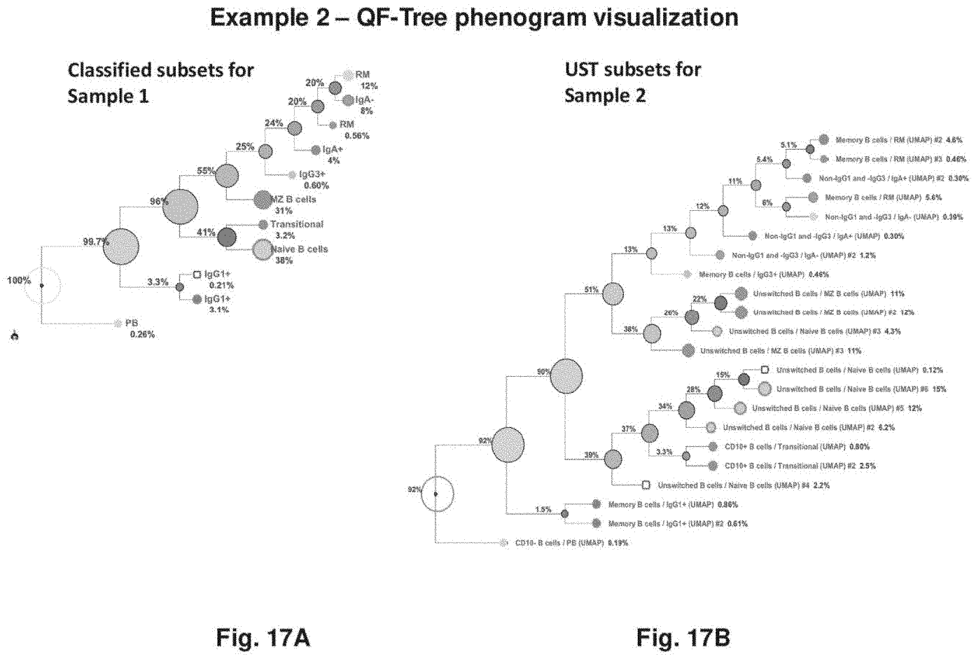

FIG. 16B is a graph of the result of supervised UMAP on a first sample in the sample database (“sample 1), which is used for as a training sample. FIG. 16C is a graph of the result of performing supervised template-guided UMAP on a second sample in the sample database (“sample 2”), followed by recognition and classification via DBM and QFM to identify subset/subpopulation/grouping boundaries. FIGS. 17A and 17B are QF-tree visualizations of the classified subsets for sample 1 and the UST subsets for sample 2.

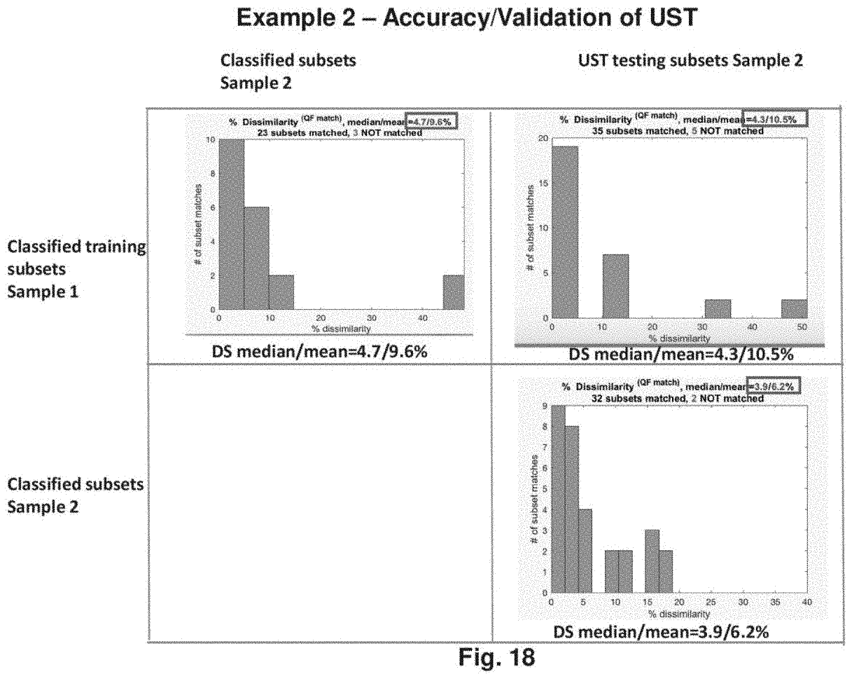

FIG. 18 includes graphs showing dissimilarity score for determining and/or verifying the accuracy of the UST subset determination. As shown in FIG. 18, the median/mean dissimilarity scores between the matched manually classified training subsets for sample 1 and the sample 2 subsets determined by UST were 4.3%/10.5% (corresponding to QFM match scenario A), which are similar to the 4.7%/9.6% median/mean dissimilarity scores between the matched manually classified sample 1 training subsets and the manually classified sample 2 subsets (corresponding to QFM match scenario D), indicating that the identification and classification of subsets in the sample 2 data based on supervised template-guided UMAP performed as well or better than manual classification of subsets in the sample 2 data. The lower right corner shows median/mean dissimilarity scores between the matched manually classified training Sample 2 subsets and the Sample 2 determined by UST were 3.9%/6.2% (corresponding to QFM match scenario C).

### Example 3: Very Similar Subset Frequencies (27 CyTOF Parameters Classifying 31 Subsets)

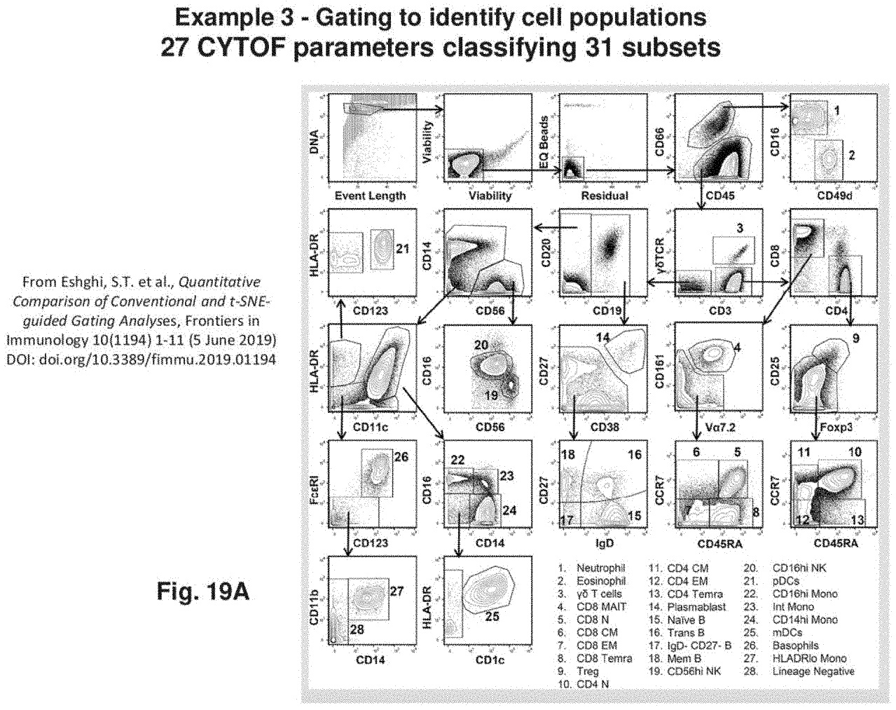

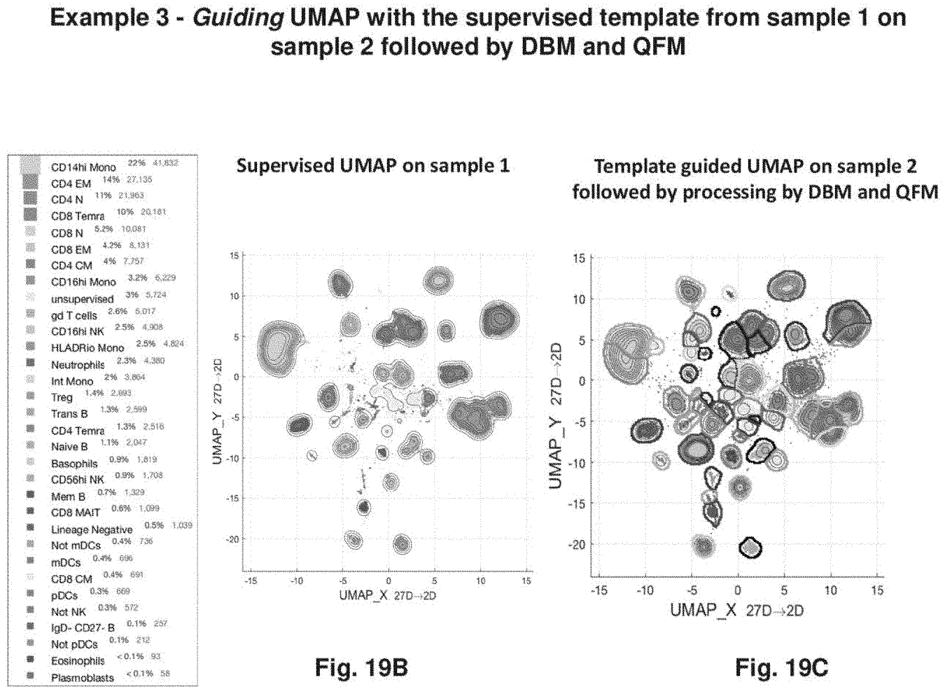

Supervised template-guided UMAP was performed on mass cytometry, specifically CyTOF, data from mononuclear cells (PMBCs) obtained from healthy donors. CyTOF has been previously described, for example in Bendall et al. (Science, Vol. 332, 6 May 2011) and Bendall and Nolan (Nature Biotechnology, Vol. 30 No. 7, July 2012), both of which are incorporated by reference in their entireties herein. In the paper, the data was labeled based on gates determined using t-SNE-guided gating analysis as shown in the graphs of FIG. 19A. Further information regarding the cells and the gating may be found in Eshghi, S. T. et al., Quantitative Comparison of Conventional and t-SNE-guided Gating Analyses, Frontiers in Immunology 10(1194) 1-11 (5 Jun. 2019) DOI: doi.org/10.3389/fimmu.2019.01194. In the paper 31 parameters were measured, but only 27 parameters were used for phenotyping and the other parameters were used for stimulation detection.

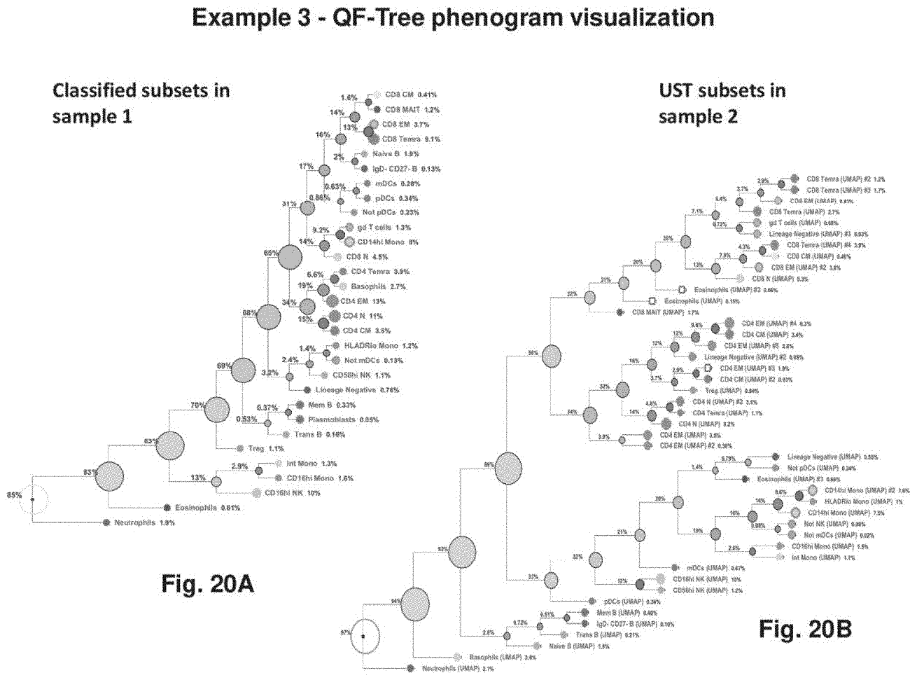

FIG. 19B shows the result of supervised UMAP on a first sample in the shared sample set (“sample 1”), which was used for the supervised template. The labels for the first sample were determined using manual gating. FIG. 19C shows the result of performing supervised template-guided UMAP on a different sample in the shared sample set (“sample 2”), followed by DBM and QFM to identify subset/subpopulation/grouping boundaries and recognize and classify subsets in the second sample. FIGS. 20A and 20B are QF-tree phenogram visualizations of the classified subsets for sample 1 and the UST subsets for sample 2.

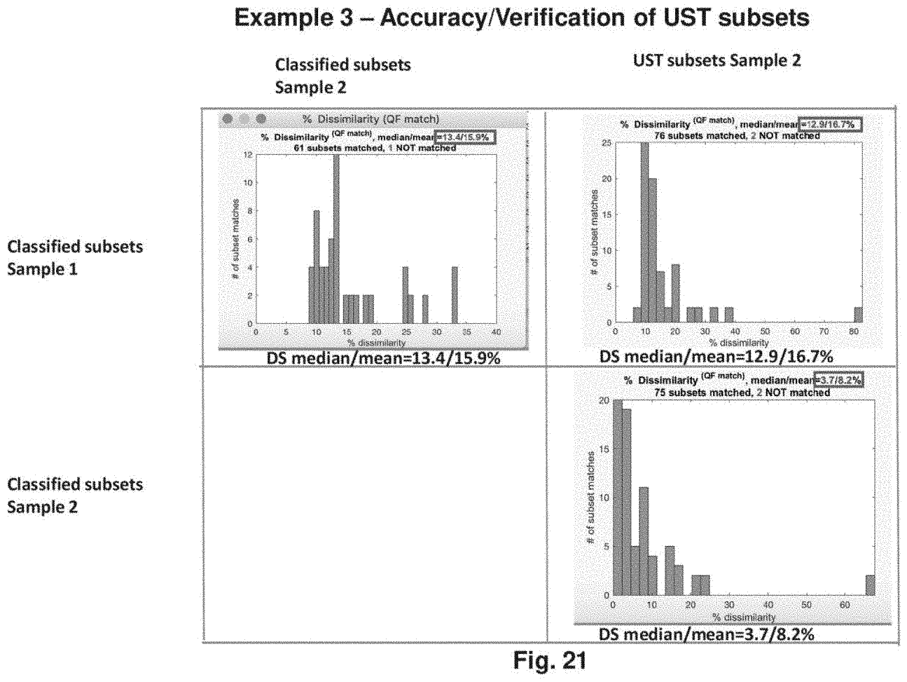

FIG. 21 includes graphs showing dissimilarity scores for determining and/or verifying the accuracy of the UST subset determination. As shown in FIG. 21, the median/mean dissimilarity scores between the matched manually classified training subsets for sample 1 and the sample 2 subsets determined by UST were 12.9%/16.7% (upper right corresponding to QF match scenario A), which were about the same as the 13.4%/15.9% median/mean dissimilarity scores between the matched manually classified sample 1 training subsets and the manually classified sample 2 subsets (upper left corresponding to QF match scenario D), indicating that the identification of subsets in the sample 2 data based on supervised template-guided UMAP performed as well or better than manual classification of subsets in the sample 2 data. The lower right corner shows that median/mean dissimilarity scores between the matched manually classified training Sample 2 subsets and the Sample 2 subsets determined by UST were 3.7%/8.2% (corresponding to QFM match scenario C).

### Example 4: Very Similar Subset Frequencies (39 CyTOF Parameters Classifying 24 Subsets)

Supervised template-guided UMAP was performed on high dimensional data mass cytometry data. Further information regarding the cells and the gating may be found in Samusik, N., Good, Z., Spitzer, M. et al., Automated mapping of phenotype space with single-cell data, Nature Methods 13:493-496 (2016) DOI: doi.org/10.1038/nmeth.3863.

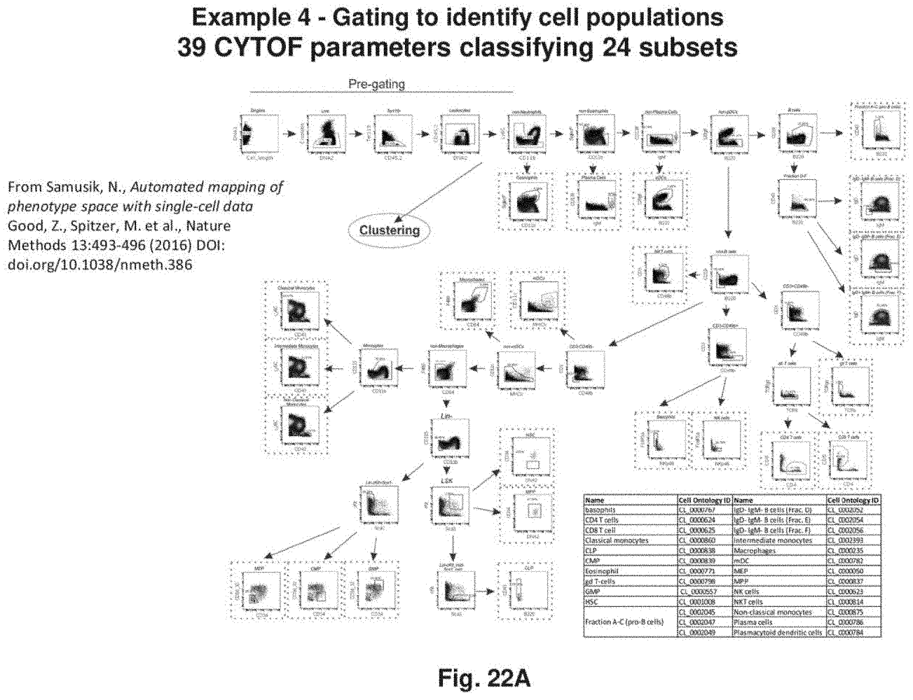

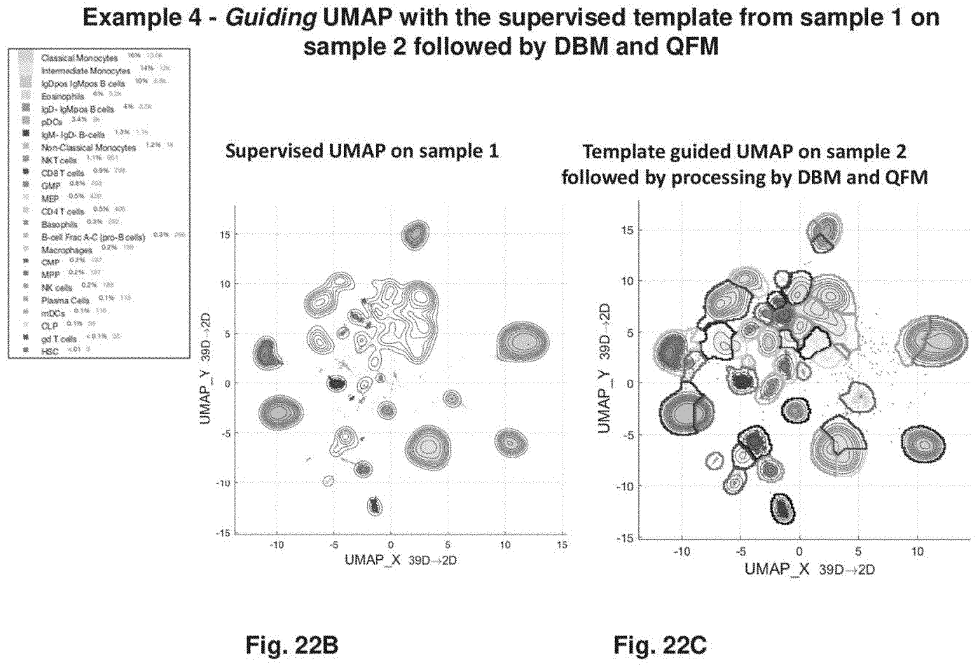

FIG. 22A includes graphs showing the results of gating to identify the 24 subsets. This data showed very similar subset frequencies with 39 CYOF parameters classifying 24 subsets.

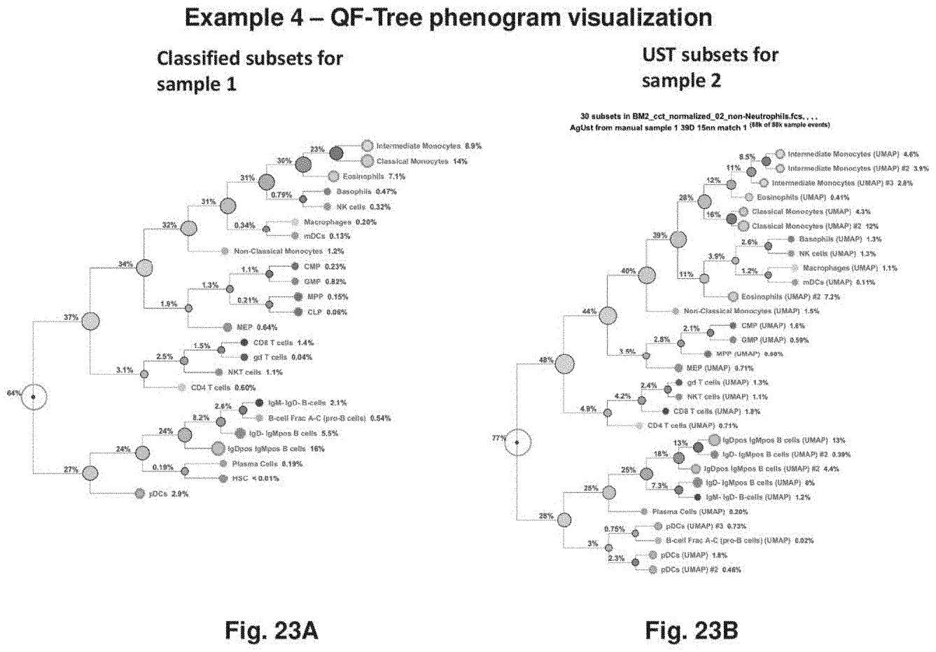

FIG. 22B is a graph of the result of supervised UMAP on a first sample in the sample database (“sample 1”), which is used for as a training sample. FIG. 22C is a graph of the result of performing supervised template-guided UMAP on a different sample in the sample database (“sample 2”), followed by DBM and QFM to identify subset/subpopulation/grouping boundaries, recognize and classify subsets and subpopulations in sample 2. FIGS. 23A and 23B are QF-tree phenogram visualizations of the classified subsets for sample 1 and the UST subsets for sample 2, respectively.

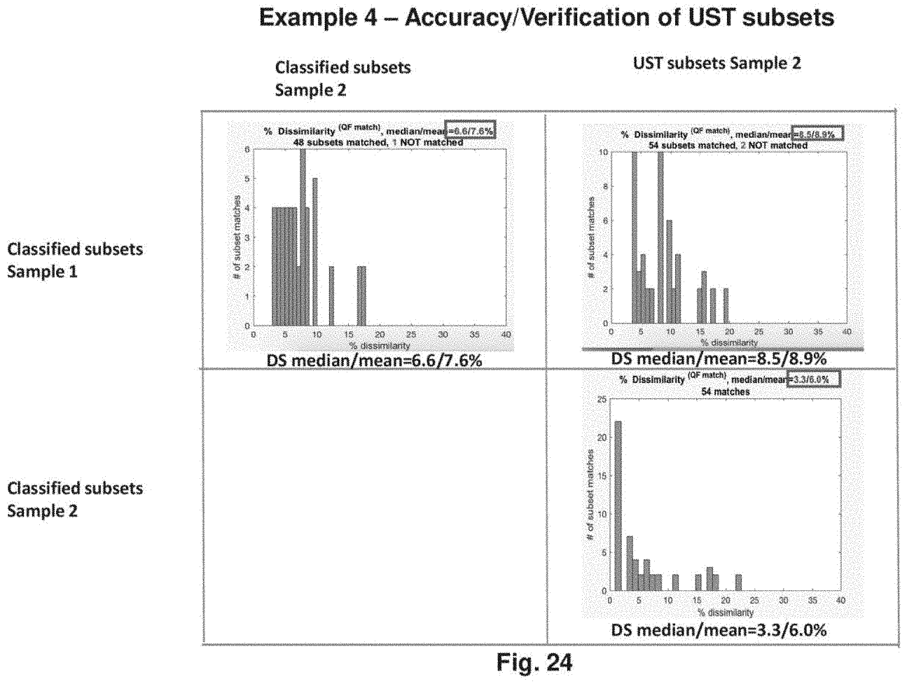

FIG. 24 includes graphs showing dissimilarity scores for determining and/or verifying the accuracy of the UST subset determination. As shown in FIG. 24, the median/mean dissimilarity scores between the matched manually classified training subsets for sample 1 and the sample 2 subsets determined by UST were 8.5%/8.9% (upper right corner corresponding to QFM match scenario A), which were similar to, but slightly worse than the 6.6%/7.6% median/mean dissimilarity scores between the matched manually classified sample 1 training subsets and the manually classified sample 2 subsets (upper left corner corresponding to QFM match scenario D), indicating that the identification of subsets in the sample 2 data based on supervised template-guided UMAP performed almost as well as manual classification of subsets in the sample 2 data. The lower right corner shows that median/mean dissimilarity scores between the matched manually classified training Sample 2 subsets and the Sample 2 subsets determined by UST were 3.3%/6.0% (corresponding to QFM match scenario C).

### Example 5: UST for Disease Relevant Rare Subsets (8 Scatter/Fluorescent Parameters Classifying One Subset)

Chronic Rhinosinusitis (CRS) is a chronic inflammation of nasal sinuses with significant quality-of-life impairment. In the United States, CRS has an estimated prevalence of 1% to 5%. It is very likely that host immune system plays a prominent role in CRS pathology with B cells representing a major component of an adaptive immune response with production of antibodies. The authors of the paper (Min, J. Y., Nayak, J. V., Hulse, K. E., et al., Evidence for altered levels of IgD in the nasal airway mucosa of patients with chronic rhinosinusitis, J Allergy Clin Immunol. 2017; 140(6):1562-1571.e5. doi:10.1016/j.jaci.2017.05.032) found a novel yet low frequency occurring IgD plasmablast population unique to nasal tissues of CRS patients.

UMAP was performed on flow cytometry data for cells from a CRS nasal tissue sample, from normal nasal tissue, and from matching peripheral blood. Further information regarding the cells and the gating may be found in Min, J. Y., Nayak, J. V., Hulse, K. E., et al., Evidence for altered levels of IgD in the nasal airway mucosa of patients with chronic rhinosinusitis, J Allergy Clin Immunol. 2017; 140(6):1562-1571.e5.

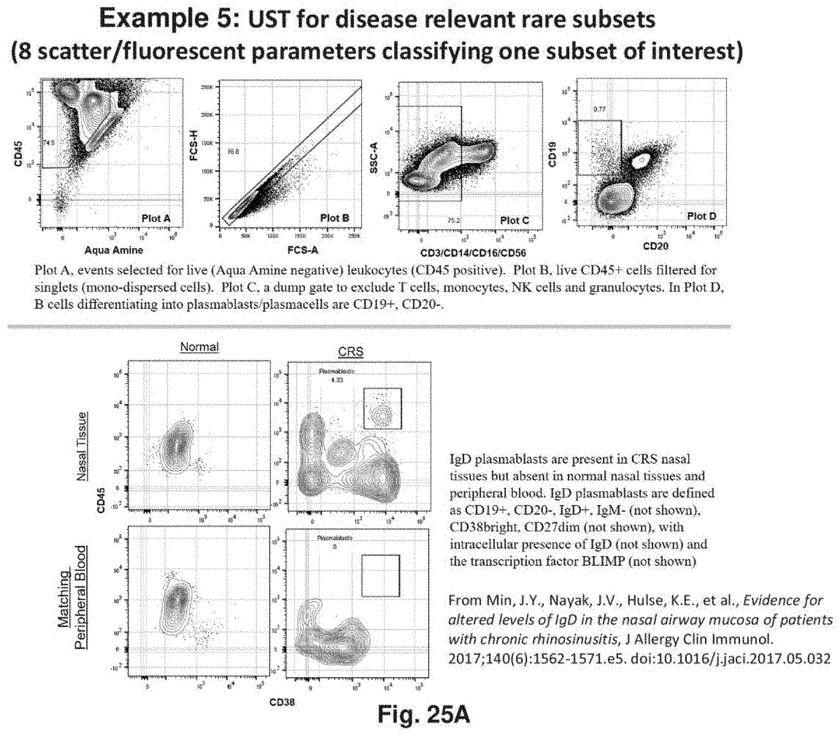

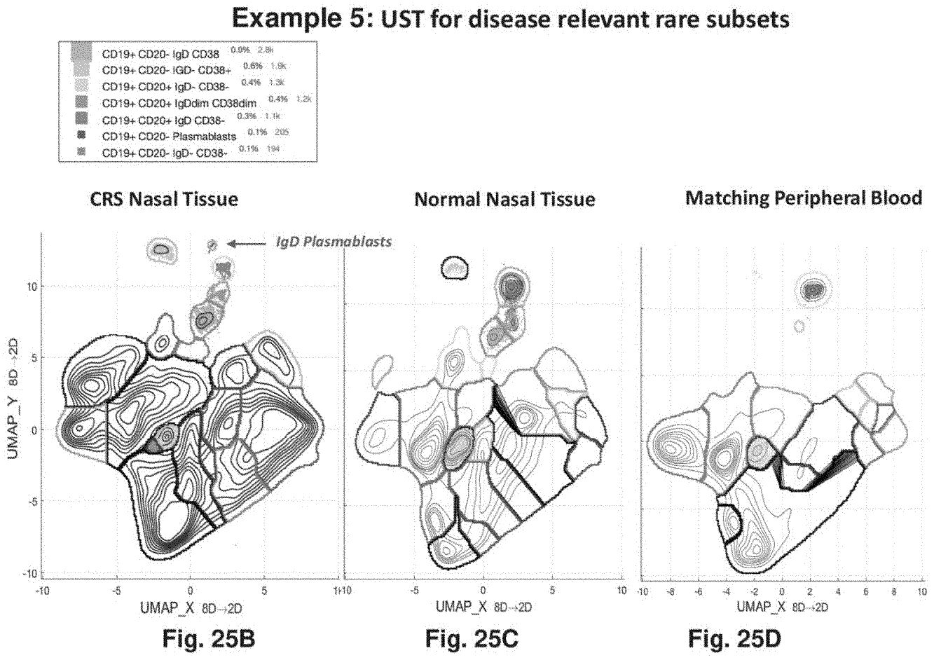

For diagnostic scenarios, the data that includes the diagnostic cell population was used as training data for the supervised template. FIG. 25B shows supervised UMAP applied to the CRS nasal tissue data. FIG. 25C shows supervised template-guided UMAP applied to the normal nasal tissue data. FIG. 25D shows supervised template-guided UMAP applied to matching peripheral blood data. The low-D data for the CRS nasal tissue shows a grouped subset of IGD plasmablasts in FIG. 25B indicating the presence of the CRS condition, which is does not have a matching subset in the low-D normal nasal tissue data in FIG. 25C or in the matching peripheral blood in FIG. 25D.

While the present invention has been described with reference to the specific embodiments and examples thereof it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present invention. All such modifications are intended to be within the scope of the claims appended hereto.

1. A method for identifying distributions of functional subpopulations of cells, the method comprising:
obtaining or accessing first training data including measurements of a plurality of parameters of cells in a first training cell population and including one of a plurality of subpopulation labels for each cell in the first training cell population, the plurality of parameters including more than five parameters, and the subpopulation labels identifying different functional subpopulations of cells in the first training cell population;
performing supervised uniform manifold approximation and projection on the first training data using the subpopulation labels for supervision to produce first reduced parameter data corresponding to measurements of the plurality of parameters of cells in the first training cell population in a reduced parameter dataspace;
obtaining or accessing second data including measurements of the plurality of parameters for cells in a second cell population;
performing template-guided uniform manifold approximation and projection on the second data employing the first reduced parameter data corresponding to the first training cell population as template data to produce second reduced parameter data corresponding to measurements of the plurality of parameters of cells in the second cell population; and
identifying subpopulations of the second cell population and recognizing at least some of the subpopulations of the second cell population as corresponding to at least some of the subpopulation labels of cells in the first training cell population based on the second reduced parameter data.

2. The method of claim 1, further comprising applying quadrative form matching to the subpopulations for the first training cell population and the identified subpopulations of the second cell population based on the second reduced parameter data to determine the accuracy of the identification and recognition of subpopulations of the second cell population as corresponding to subpopulations of the first training cell population.

3. The method of claim 2, wherein applying the quadrative form matching to the subpopulations for the first training cell population and the identified subpopulations of the second cell population based on the second reduced parameter data to determine the accuracy of the identification and recognition of at least some of the subpopulations of the second cell population as corresponding to subpopulations of the first training cell population comprises:
determining a first set of dissimilarity scores for corresponding matching subpopulations between labeled subpopulations in the first training cell population and subpopulations in the second cell population identified based on the second reduced parameter data; and
determining a first overall dissimilarity score based on the first set of dissimilarity scores.

4. The method of claim 2, wherein applying the quadrative form matching to the subpopulations for the first training cell population and the identified subpopulations of the second cell population based on the second reduced parameter data to determine the accuracy of the identification and recognition of at least some of the subpopulations of the second cell population as corresponding to subpopulations of the first training cell population comprises two or more of:
determining a first set of dissimilarity scores for corresponding matching subpopulations between labeled subpopulations in the first training cell population and subpopulations in the second cell population identified based on the second reduced parameter data, and determining a first overall dissimilarity score based on the first set of dissimilarity scores;
determining a second set of dissimilarity scores for corresponding matching subpopulations between labeled subpopulations in the first training cell population and subpopulations in the second cell population identified based on obtained third data including subpopulation labels identifying different functional subpopulations of cells in the second cell population based on external classification, and determining a second overall dissimilarity score based on the second set of dissimilarity scores; and
determining a third set of dissimilarity scores for corresponding matching subpopulations between subpopulations in the second cell population identified based on obtained third data including subpopulation labels identifying different functional subpopulations of cells in the second cell population based on external classification and subpopulations in the second cell population identified based on the second reduced parameter data, and determining a third overall dissimilarity score based on the second set of dissimilarity scores.

5. The method of claim 4, further comprising displaying the two or more of the first overall dissimilarity score, second overall dissimilarity score, and third overall dissimilarity score on a graphical user interface.

6. The method of claim 4, further comprising, comparing the two or more of the first overall dissimilarity score, second coverall dissimilarity score, and third overall dissimilarity score.

7. The method of claim 1, wherein identifying subpopulations of the second cell population and recognizing at least some of the subpopulations of the second cell population as corresponding to at least some of the subpopulation labels of cells in the first training cell population based on the second reduced parameter data comprises one or more of:
a) detecting clusters in the second reduced parameter data and determining a most similar median or mean of clusters between the subpopulations in the first training cell population and the detected clusters in the second reduced parameter data;
b) detecting clusters in the second reduced parameter data and determining QFM dissimilarity scores on combinations of subpopulations in the first training cell population and the detected clusters in the second reduced parameter data;
c) for each item in the second reduced parameter data, assigning the associated label of the item in the first training set that is closest to the item in the second reduced parameter data set; and
d) for each item in the second reduced parameter data, assigning the associated label of the item in the first training set that is closest to the item in the second reduced parameter data set, detecting clusters in the second reduced parameter data and, for each cluster in the second reduced parameter data, determining a closeness of the cluster in the second reduced parameter data to a subpopulation in the first training data set based on a subpopulation label with a highest number of label assignments for each item in the second test data cluster.

8. The method of claim 7, wherein the method further comprises:
displaying two or more options for identifying subpopulations of the second cell population and recognizing at least some of the subpopulations of the second cell population as corresponding to at least some of the subpopulation labels of cells in the first training cell population based on the second reduced parameter data in a graphical user interface; and
receiving a selection of at least one of the two or more options for identifying subpopulations of the second cell population and recognizing at least some of the subpopulations of the second cell population as corresponding to at least some of the subpopulation labels of cells in the first training cell population based on the second reduced parameter data.

9. The method of claim 1, wherein identifying subpopulations of the second cell population and recognizing at least some of the subpopulations of the second cell population as corresponding to at least some of the subpopulation labels of cells in the first training cell population based on the second reduced parameter data comprises employing density based merging to identify or confirm boundaries of the subpopulations in the second reduced parameter data.

10. The method of claim 1, further comprising generating a quadrative form tree or phenogram of the subpopulations in the second cell population for visualization of relatedness between identified subpopulations.

11. The method of claim 1, further comprising prior to, during, or after performing template-guided uniform manifold approximation and projection on the second data employing the first reduced parameter data as template data to produce second reduced parameter data:
determining whether the second data appears to include one or more subpopulations of cells that do not belong to any of the labeled subpopulations in the first training cell population; and
where it is determined that the second data appears to include one or more subpopulations of cells that do not belong to any of the labeled subpopulations in the first training cell population, performing one or more of:
providing a user a notification;
presenting a user with option, via a graphical user interface, to select performance of an alternative to performance of the template-guided uniform manifold approximation and projection on the second data employing the first reduced parameter data as template data; and
suspending, pausing, terminating or not initiating performance of the template-guided uniform manifold approximation and projection on the second data employing the first reduced parameter data as template data.

12. The method of claim 11, where it is determined that the second data appears to include one or more subpopulations of cells that do not belong to any of the labeled subpopulations in the first training cell population, the method further comprises:
upon receipt of a user selection, performing the alterative to performance of the template-guided uniform manifold approximation and projection on the second data employing the first reduced parameter data as template data, wherein the alternative comprises:
performing a re-supervised reduction on the second test data that appears to correspond to one or more new subpopulations including generating supervising labels for the second test set and performing supervised UMAP on the second data using the generated supervising labels; or
after performing supervised UMAP on the first training data, performing a joined transform method in which template-guided UMAP is modified such that both the first training data set and the second data set are used to determine the nearest neighbors of each point in the second data set, and such that that during stochastic gradient descent, and application of attractive and repulsive forces, the first training data points do not move as their position is considered already correctly determined, while the second test data points move.

13. The method of claim 1, wherein the first data comprises flow cytometry data.

14. The method of claim 1, wherein the first data comprises mass cytometry data.

15. The method of claim 1, wherein the method detects the presence of a rare disease relevant subset in the second data.

16. The method of claim 2, wherein the method further comprises, based on a determination that the identification of subpopulations of the second cell population is accurate:
obtaining or accessing third data including measurements of the plurality of parameters for cells in a third cell population;
performing template-guided uniform manifold approximation and projection on the third data employing the first reduced parameter data corresponding to the first training cell population as template data to produce third reduced parameter data corresponding to measurements of the plurality of parameters of cells in the third cell population; and
identifying subpopulations of the third cell population and recognizing at least some of the subpopulations of the third cell population as corresponding to at least some of the subpopulation labels of cells in the first training cell population based on the third reduced parameter data.

17. The method of claim 1, wherein the method identifies the presence of a rare disease relevant functional subpopulation of cells in the second cell population.

18. The method of claim 1, wherein the method identifies the absence of a disease relevant functional subpopulation of cells in the second cell population.

19. A method for identifying subpopulations of items from high dimensional data regarding a population of items, the method comprising:
obtaining or accessing first training data including values of a plurality of parameters for items in first training item population and including one of a plurality of subpopulation labels for each item in the first training item population, the plurality of parameters including more than five parameters, and the subpopulation labels identifying different subpopulations of items in the first training item population;
performing supervised uniform manifold approximation and projection on the first training data using the subpopulation labels for supervision to produce first reduced parameter data corresponding to the values of the plurality of parameters for the items in the first training item population in a reduced parameter dataspace;
obtaining or accessing second data including values of the plurality of parameters for items in a second item population;
performing template-guided uniform manifold approximation and projection on the second data employing the first reduced parameter data corresponding to the first training item population as template data to produce second reduced parameter data corresponding to values the plurality of parameters for items in the second item population; and
identifying subpopulations of the second item population and recognizing at least some of the subpopulations of the second item population as corresponding to at least some of the subpopulation labels of items in the first training item population based on the second reduced parameter data.

20. The method of claim 19, further comprising applying quadrative form matching to the subpopulations for the first training item population and the identified subpopulations of the second item population based on the second reduced parameter data to determine the accuracy of the identification and recognition of subpopulations of the second item population as corresponding to subpopulations of the first training item population.

21. The method of claim 20, wherein applying the quadrative form matching to the subpopulations for the first training item population and the identified subpopulations of the second item population based on the second reduced parameter data to determine the accuracy of the identification and recognition of at least some of the subpopulations of the second item population as corresponding to subpopulations of the first training item population comprises:
determining a first set of dissimilarity scores for corresponding matching subpopulations between labeled subpopulations in the first training item population and subpopulations in the second item population identified based on the second reduced parameter data; and
determining a first overall dissimilarity score based on the first set of dissimilarity scores.

22. The method of claim 20, wherein applying the quadrative form matching to the subpopulations for the first training item population and the identified subpopulations of the second item population based on the second reduced parameter data to determine the accuracy of the identification and recognition of at least some of the subpopulations of the second item population as corresponding to subpopulations of the first training item population comprises two or more of:
determining a first set of dissimilarity scores for corresponding matching subpopulations between labeled subpopulations in the first training item population and subpopulations in the second item population identified based on the second reduced parameter data, and determining a first overall dissimilarity score based on the first set of dissimilarity scores;
determining a second set of dissimilarity scores for corresponding matching subpopulations between labeled subpopulations in the first training item population and subpopulations in the second item population identified based on obtained third data including subpopulation labels identifying different functional subpopulations of items in the second item population based on external classification, and determining a second overall dissimilarity score based on the second set of dissimilarity scores; and
determining a third set of dissimilarity scores for corresponding matching subpopulations between subpopulations in the second item population identified based on obtained third data including subpopulation labels identifying different functional subpopulations of items in the second item population based on external classification and subpopulations in the second item population identified based on the second reduced parameter data, and determining a third overall dissimilarity score based on the second set of dissimilarity scores.

23. The method of claim 22, further comprising displaying the two or more of the first overall dissimilarity score, second overall dissimilarity score, and third overall dissimilarity score on a graphical user interface.

24. The method of claim 22, further comprising, comparing the two or more of the first overall dissimilarity score, second coverall dissimilarity score, and third overall dissimilarity score.

25. The method of claim 19, wherein identifying subpopulations of the second item population and recognizing at least some of the subpopulations of the second item population as corresponding to at least some of the subpopulation labels of items in the first training item population based on the second reduced parameter data comprises one or more of:
a) detecting clusters in the second reduced parameter data and determining a most similar median or mean of clusters between the subpopulations in the first training item population and the detected clusters in the second reduced parameter data;
b) detecting clusters in the second reduced parameter data and determining QFM dissimilarity scores on combinations of subpopulations in the first training item population and the detected clusters in the second reduced parameter data;
c) for each item in the second reduced parameter data, assigning the associated label of the item in the first training set that is closest to the item in the second reduced parameter data set; and
d) for each item in the second reduced parameter data, assigning the associated label of the item in the first training set that is closest to the item in the second reduced parameter data set, detecting clusters in the second reduced parameter data and, for each cluster in the second reduced parameter data, determining a closeness of the cluster in the second reduced parameter data to a subpopulation in the first training data set based on a subpopulation label with a highest number of label assignments for each item in the second test data cluster.

26. The method of claim 25, wherein the method further comprises:
displaying two or more options for identifying subpopulations of the second item population and recognizing at least some of the subpopulations of the second item population as corresponding to at least some of the subpopulation labels of items in the first training item population based on the second reduced parameter data in a graphical user interface; and
receiving a selection of at least one of the two or more options for identifying subpopulations of the second item population and recognizing at least some of the subpopulations of the second item population as corresponding to at least some of the subpopulation labels of items in the first training item population based on the second reduced parameter data.

27. The method of claim 19, wherein identifying subpopulations of the second item population and recognizing at least some of the subpopulations of the second item population as corresponding to at least some of the subpopulation labels of items in the first training item population based on the second reduced parameter data comprises employing density based merging to identify or confirm boundaries of the subpopulations in the second reduced parameter data.

28. The method of claim 19, further comprising generating a quadrative form tree or phenogram of the subpopulations in the second item population for visualization of relatedness between identified subpopulations.

29. The method of claim 19, further comprising prior to, during, or after performing template-guided uniform manifold approximation and projection on the second data employing the first reduced parameter data as template data to produce second reduced parameter data:
determining whether the second data appears to include one or more subpopulations of items that do not belong to any of the labeled subpopulations in the first training item population; and
where it is determined that the second data appears to include one or more subpopulations of items that do not belong to any of the labeled subpopulations in the first training item population, performing one or more of:
providing a user a notification;
presenting a user with option, via a graphical user interface, to select performance of an alternative to performance of the template-guided uniform manifold approximation and projection on the second data employing the first reduced parameter data as template data; and
suspending, pausing, terminating or not initiating performance of the template-guided uniform manifold approximation and projection on the second data employing the first reduced parameter data as template data.

30. The method of claim 29, where it is determined that the second data appears to include one or more subpopulations of items that do not belong to any of the labeled subpopulations in the first training item population, the method further comprises:
upon receipt of a user selection, performing the alterative to performance of the template-guided uniform manifold approximation and projection on the second data employing the first reduced parameter data as template data, wherein the alternative comprises:
performing a re-supervised reduction on the second test data that appears to correspond to one or more new subpopulations including generating supervising labels for the second test set and performing supervised UMAP on the second data using the generated supervising labels; or
after performing supervised UMAP on the first training data, performing a joined transform method in which template-guided UMAP is modified such that both the first training data set and the second data set are used to determine the nearest neighbors of each point in the second data set, and such that that during stochastic gradient descent, and application of attractive and repulsive forces, the first training data points do not move as their position is considered already correctly determined, while the second test data points move.

31. The method of claim 20, wherein the method further comprises, based on a determination that the identification of subpopulations of the second item population is accurate:
obtaining or accessing third data including values of the plurality of parameters for items in a third item population;
performing template-guided uniform manifold approximation and projection on the third data employing the first reduced parameter data corresponding to the first training item population as template data to produce third reduced parameter data corresponding to measurements of the plurality of parameters of items in the third item population; and
identifying subpopulations of the third item population and recognizing at least some of the subpopulations of the third item population as corresponding to at least some of the subpopulation labels of items in the first training item population based on the third reduced parameter data.

32. A system for identifying subpopulations of items from high dimensional data regarding a population of items, the system comprising:
storage configured to hold:
first training data including values of a plurality of parameters for items in first training item population and including one of a plurality of subpopulation labels for each item in the first training item population, the plurality of parameters including more than five parameters, and the subpopulation labels identifying different subpopulations of items in the first training item population; and
second data including values of the plurality of parameters for items in a second item population; and
one or more processors in communication with the storage and configured to execute instructions comprising instructions to:
perform supervised uniform manifold approximation and projection on the first training data using the subpopulation labels for supervision to produce first reduced parameter data corresponding to the values of the plurality of parameters for the items in the first training item population in a reduced parameter dataspace;
perform template-guided uniform manifold approximation and projection on the second data employing the first reduced parameter data corresponding to the first training item population as template data to produce second reduced parameter data corresponding to values the plurality of parameters for items in the second item population; and
identify subpopulations of the second item population and recognize at least some of the subpopulations of the second item population corresponding to at least some of the subpopulation labels of items in the first training item population based on the second reduced parameter data.

33. The system of claim 32, wherein the instruction further include instructions to apply quadrative form matching to the subpopulations for the first training item population and the identified subpopulations of the second item population based on the second reduced parameter data to determine the accuracy of the identification and recognition of subpopulations of the second item population as corresponding to subpopulations of the first training item population.

34. The system of claim 33, wherein applying the quadrative form matching to the subpopulations for the first training item population and the identified subpopulations of the second item population based on the second reduced parameter data to determine the accuracy of the identification and recognition of at least some of the subpopulations of the second item population as corresponding to subpopulations of the first training item population comprises:
determining a first set of dissimilarity scores for corresponding matching subpopulations between labeled subpopulations in the first training item population and subpopulations in the second item population identified based on the second reduced parameter data; and
determining a first overall dissimilarity score based on the first set of dissimilarity scores.

35. The system of claim 33, wherein applying the quadrative form matching to the subpopulations for the first training item population and the identified subpopulations of the second item population based on the second reduced parameter data to determine the accuracy of the identification and recognition of at least some of the subpopulations of the second item population as corresponding to subpopulations of the first training item population comprises two or more of:
determining a first set of dissimilarity scores for corresponding matching subpopulations between labeled subpopulations in the first training item population and subpopulations in the second item population identified based on the second reduced parameter data, and determining a first overall dissimilarity score based on the first set of dissimilarity scores;
determining a second set of dissimilarity scores for corresponding matching subpopulations between labeled subpopulations in the first training item population and subpopulations in the second item population identified based on obtained third data including subpopulation labels identifying different functional subpopulations of items in the second item population based on external classification, and determining a second overall dissimilarity score based on the second set of dissimilarity scores; and
determining a third set of dissimilarity scores for corresponding matching subpopulations between subpopulations in the second item population identified based on obtained third data including subpopulation labels identifying different functional subpopulations of items in the second item population based on external classification and subpopulations in the second item population identified based on the second reduced parameter data, and determining a third overall dissimilarity score based on the second set of dissimilarity scores.

36. The system of claim 35, wherein the instruction further include instructions to display the two or more of the first overall dissimilarity score, second overall dissimilarity score, and third overall dissimilarity score on a graphical user interface.

37. The system of claim 35, wherein the instruction further include instructions to compare the two or more of the first overall dissimilarity score, second coverall dissimilarity score, and third overall dissimilarity score.

38. The system of claim 32, wherein identifying subpopulations of the second item population and recognizing at least some of the subpopulations of the second item population as corresponding to at least some of the subpopulation labels of items in the first training item population based on the second reduced parameter data comprises one or more of:
a) detecting clusters in the second reduced parameter data and determining a most similar median or mean of clusters between the subpopulations in the first training item population and the detected clusters in the second reduced parameter data;
b) detecting clusters in the second reduced parameter data and determining QFM dissimilarity scores on combinations of subpopulations in the first training item population and the detected clusters in the second reduced parameter data;
c) for each item in the second reduced parameter data, assigning the associated label of the item in the first training set that is closest to the item in the second reduced parameter data set; and
d) for each item in the second reduced parameter data, assigning the associated label of the item in the first training set that is closest to the item in the second reduced parameter data set, detecting clusters in the second reduced parameter data and, for each cluster in the second reduced parameter data, determining a closeness of the cluster in the second reduced parameter data to a subpopulation in the first training data set based on a subpopulation label with a highest number of label assignments for each item in the second test data cluster.

39. The system of claim 38, wherein the instructions further include instructions to:
display two or more options for identifying subpopulations of the second item population and recognizing at least some of the subpopulations of the second item population as corresponding to at least some of the subpopulation labels of items in the first training item population based on the second reduced parameter data in a graphical user interface; and
receive a selection of at least one of the two or more options for identifying subpopulations of the second item population and recognizing at least some of the subpopulations of the second item population as corresponding to at least some of the subpopulation labels of items in the first training item population based on the second reduced parameter data.

40. The system of claim 32, wherein identifying subpopulations of the second item population and recognizing at least some of the subpopulations of the second item population as corresponding to at least some of the subpopulation labels of items in the first training item population based on the second reduced parameter data comprises employing density based merging to identify or confirm boundaries of the subpopulations in the second reduced parameter data.

41. The system of claim 32, wherein the instruction further include instructions to generate a quadrative form tree or phenogram of the subpopulations in the second item population for visualization of relatedness between identified subpopulations.

42. The system of claim 32, wherein the instruction further include instructions to prior to, during, or after performing template-guided uniform manifold approximation and projection on the second data employing the first reduced parameter data as template data to produce second reduced parameter data:
determine whether the second data appears to include one or more subpopulations of items that do not belong to any of the labeled subpopulations in the first training item population; and
where it is determined that the second data appears to include one or more subpopulations of items that do not belong to any of the labeled subpopulations in the first training item population, perform one or more of:
providing a user a notification;
presenting a user with option, via a graphical user interface, to select performance of an alternative to performance of the template-guided uniform manifold approximation and projection on the second data employing the first reduced parameter data as template data; and
suspending, pausing, terminating or not initiating performance of the template-guided uniform manifold approximation and projection on the second data employing the first reduced parameter data as template data.

43. The system of claim 42, where it is determined that the second data appears to include one or more subpopulations of items that do not belong to any of the labeled subpopulations in the first training item population, the instructions further comprise instructions to:
upon receipt of a user selection, perform the alterative to performance of the template-guided uniform manifold approximation and projection on the second data employing the first reduced parameter data as template data, wherein the alternative comprises:
performing a re-supervised reduction on the second test data that appears to correspond to one or more new subpopulations including generating supervising labels for the second test set and performing supervised UMAP on the second data using the generated supervising labels; or
after performing supervised UMAP on the first training data, performing a joined transform method in which template-guided UMAP is modified such that both the first training data set and the second data set are used to determine the nearest neighbors of each point in the second data set, and such that that during stochastic gradient descent, and application of attractive and repulsive forces, the first training data points do not move as their position is considered already correctly determined, while the second test data points move.

44. The system of claim 33, wherein the instructions further comprise instructions to:
based on a determination that the identification of subpopulations of the second item population is accurate;
obtain or access third data including values of the plurality of parameters for items in a third item population;
perform template-guided uniform manifold approximation and projection on the third data employing the first reduced parameter data corresponding to the first training item population as template data to produce third reduced parameter data corresponding to measurements of the plurality of parameters of items in the third item population; and
identify subpopulations of the third item population and recognize at least some of the subpopulations of the third item population as corresponding to at least some of the subpopulation labels of items in the first training item population based on the third reduced parameter data.
